(19) United States
(12) Patent Application Publication
(10) Pub. No.: US 2010/0321658 A1
(43) Pub. Date: Dec. 23, 2010

(54) EXPOSURE HEAD AND IMAGE FORMING APPARATUS

(75) Inventors: Takeshi Sowa, Matsumoto-shi (JP); Ken Ikuma, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/818,126

(22) Filed: Jun. 17, 2010

(30) Foreign Application Priority Data
Jun. 22, 2009 (JP) 2009-147864

(51) Int. Cl. G03B 27/52

(52) U.S. Cl. 355/55

(57) ABSTRACT

An image forming apparatus includes an image carrier; and an exposure head including a light emitting element that emits a light having a first wavelength and a light having a second wavelength, and an optical system that focuses the light having the first wavelength at a first imaging position and focuses the light having the second wavelength at a second imaging position that is different from the first imaging position with respect to the first direction, the optical system having an optical axis extending in the first direction, wherein a surface of the image carrier is located between the first imaging position and the second imaging position.

### BACKGROUND

1. Technical Field

The present invention relates to an exposure head that performs exposure by converging light emitted from light emitting elements using optical systems. The invention also relates to an image forming apparatus including the exposure head.

2. Related Art

As such an exposure head, JP-A-2008-221790 describes a line head including light emitting elements and optical systems that converge light emitted from the light emitting elements onto an exposure surface. The exposure surface is exposed with the converged light (spot).

Exposure is generally performed on an exposure surface of an image carrier such as a photosensitive drum. In this exposure technique, an exposure head, which is disposed so as to face the image carrier, forms converged light on the surface of the photosensitive drum. However, when, for example, a photosensitive is used as the image carrier, the cross-sectional shape of the photosensitive drum is not a perfect circle and is uneven within tolerance. As a result, the position of the surface of the image carrier deviates relative to the exposure head, so that the sizes of the converged light formed on the surface of the image carrier may deviate.

### SUMMARY

An advantage of some aspects of the invention is that the sizes of converged light are made uniform even if the position of the surface of the image carrier or the exposure surface deviates, whereby a good exposure is realized.

An image forming apparatus according to an aspect of the invention includes an image carrier; and an exposure head including a light emitting element that emits a light having a first wavelength and a light having a second wavelength, and an optical system that focuses the light having the first wavelength at a first imaging position and focuses the light having the second wavelength at a second imaging position that is different from the first imaging position with respect to the first direction, the optical system having an optical axis extending in the first direction, wherein a surface of the image carrier is located between the first imaging position and the second imaging position.

An exposure head according to another aspect of the invention includes a light emitting element that emits a light having a first wavelength and a light having a second wavelength; and an optical system that focuses the light having the first wavelength at a first imaging position and focuses the light having the second wavelength at a second imaging position, wherein the first imaging position is located on one side of an exposure surface and the second imaging position is located on the other side of the exposure surface.

In the image forming apparatus and the exposure head, the (first) light emitting element emits the light having the first wavelength and the light having the second wavelength, and the (first) optical system focuses the light having the first wavelength at the first imaging position and focuses the light having the second wavelength at the second imaging position. By making the (first) optical system focus the light at the first and second imaging positions that are different from each other, an effect is obtained in that the apparent depth of focus of the (first) optical system is increased. Moreover, the surface of the image carrier is located between the first imaging position and the second imaging position (the first imaging position is located on one side of the exposure surface, and the second imaging position is located on the other side of the exposure surface). Therefore, even if the surface (exposure surface) of the image carrier deviates to some extent, variation of the size of the converged light formed by the optical system can be suppressed, whereby a good exposure can be realized.

It is preferable that the light emitting element have an emission spectrum having peaks at the first wavelength and the second wavelength. In this case, the apparent depth of focus is effectively increased, whereby a better exposure can be realized.

It is preferable that the image carrier be cylindrical, and the exposure head expose the surface of the image carrier that rotates. However, with this structure, the position of a part of the surface of the image carrier that faces the exposure head may periodically vary. As a result, the size of the light converged onto the surface of the image carrier surface (converged light) may vary in accordance with the position of the surface of the image carrier. Therefore, it is preferable that a distance Δ between the first imaging position and the second imaging position with respect to an optical axis direction of the optical system be equal to or larger than a width by which the surface of the image carrier moves in the optical axis direction of the optical system while the image carrier rotates once. In this case, variation of the size of the converged light caused by the positional variation of the surface of the image carrier can be suppressed, whereby a better exposure can be realized.

The invention has an advantage in that the apparent depth of focus of the optical system is increased, because the optical system is configured to focus light at different imaging positions. However, if the distance Δ between the imaging positions of the optical system in the optical axis direction Doa is too large, the aberration of the converged light increase and thereby the imaging performance may deteriorate. Therefore, it is preferable that the image forming apparatus further include an aperture diaphragm for limiting an amount of light that enters the optical system, and an expression

Δ≦|m|×D/tan(u)

be satisfied, where Δ is a distance between the first imaging position and the second imaging position with respect to an optical axis direction of the optical system, D is a diameter of the light emitting element, m is a magnification of the optical system, and u is an image-side angular aperture that is half an angle between two lines connecting an image point of the optical system and ends of a diameter of an entrance pupil. In this case, influence on imaging performance such as aberration can be suppressed, whereby a better exposure can be realized.

The invention can be applied to an optical system including a plurality of exposure heads. That is, it is preferable that the exposure head further include a second light emitting element that emits a light having a third wavelength and a light having a fourth wavelength, and a second optical system that focuses the light having the third wavelength at a third imaging position and focuses the light having the fourth wavelength at a fourth imaging position, and the surface of the image carrier be located between the third imaging position and the fourth imaging position. By making the second optical system focus the light at the third imaging position and the fourth imaging position that are different from each other, an effect is obtained in that the apparent depth of focus of the second optical system is increased. Moreover, the surface of the image carrier is located between the third imaging position and the fourth imaging position (the third imaging position is located on one side of the exposure surface, and the fourth imaging position is located on the other side of the exposure surface). Therefore, even if the surface (exposure surface) of the image carrier deviates to some extent, variation of the size of the converged light formed by the second optical system can be suppressed, whereby a good exposure can be realized.

The optical axis of the optical system and the optical axis of the second optical system may extend in a predetermined first direction. With this structure, the optical system focuses a light at the vicinity of the first intersection point at which the optical axis intersects the image carrier and the second optical system focuses a light at the vicinity of the second intersection point at which the optical axis intersects the image carrier. However, if, for example, the image carrier has a finite a curvature, the intersection point may be displaced in the first direction by a distance d. In such a case, the size of the converged light formed by the optical system at the vicinity of the first intersection point and the size of the converged light formed by the second optical system at the vicinity of the second intersection point may become different from each other. Therefore, it is preferable that the optical axis of the optical system and an optical axis of the second optical system extend in the first direction, and the first imaging position and the third imaging position be separated from each other in the first direction by a distance d that is equal to a distance between a first intersection point and a second intersection point with respect to the first direction, the first intersection point being a point at which the optical axis of the optical system intersects the image carrier, the second intersection point being a point at which the optical axis of the second optical system intersects the image carrier. In this case, the imaging position of the optical system and the imaging position of the second optical system can be shifted, whereby the difference between the sizes of the converged light can be suppressed.

### BRIEF DESCRIPTION OF THE DRAWINGS

The invention will be described with reference to the accompanying drawings, wherein like numbers reference like elements.

FIG. 1 is a diagram used to describe the cause of a difference between the sizes of converged light and measures to deal therewith.

FIG. 2 is a diagram illustrating an example of an image forming apparatus to which the invention can be applied.

FIG. 3 is a block diagram of the electrical structure of the image forming apparatus illustrated in FIG. 2.

FIG. 4 is a schematic perspective view of a line head.

FIG. 5 is a plan view of a head substrate viewed from the thickness direction.

FIG. 6 is a stepped sectional view of a line head of a first embodiment taken along line VI,X-VI,X of FIG. 5.

FIG. 7 is a diagram used to describe an imaging operation performed by an optical system in the first embodiment.

FIG. 8 is a diagram used to describe an imaging operation performed by an optical system in a second embodiment.

FIG. 9 is a diagram illustrating data of wobbling of a photosensitive body represented by polar coordinates.

FIG. 10 is a stepped sectional view of a line head of a third embodiment taken along line VI,X-VI,X of FIG. 5.

FIG. 11 is a diagram for describing the optical structure of the third embodiment.

FIG. 12 is a diagram illustrating a modification of an image forming apparatus according to an aspect of the invention.

FIG. 13 is a diagram illustrating another modification of an image forming apparatus according to an aspect of the invention.

FIG. 14 is a table of lens data of an upstream optical system and a downstream optical system in an example.

FIG. 15 shows summary data about the shape of a S4 surface of the upstream optical system and the downstream optical system.

FIG. 16 shows summary data about the shape of a S7 surface of the upstream optical system and the downstream optical system.

FIG. 17 is a table of lens data of a middle optical system in the example.

FIG. 18 shows summary data about the shape of a S4 surface of the middle optical system.

FIG. 19 shows summary data about the shape of a S7 surface of the middle optical system.

FIG. 20 is a ray diagram of the upstream and downstream optical systems in a section taken in the main scanning direction.

FIG. 21 is a ray diagram of the upstream and downstream optical systems in a section taken in the sub-scanning direction.

FIG. 22 is a table of specifications of the optical system used to obtain the ray diagrams of FIGS. 20 and 21.

FIG. 23 is a graph illustrating imaging positions of two light having different wavelengths obtained by performing a simulation.

FIG. 24 is a graph illustrating imaging positions of two light having different wavelengths obtained by performing a simulation.

FIG. 25 is a graph illustrating an increase in the depth of focus of the optical system.

FIG. 26 is a graph illustrating an increase in the depth of focus of the optical system.

### DESCRIPTION OF EXEMPLARY EMBODIMENTS

As described above, the size of converged light (spots) may deviate owing to deviation in the position of the exposure surface. Hereinafter, the cause of the difference between the sizes of converged light and measures to deal therewith will be first described, and the embodiments will be described in detail.

### A. Cause of Difference Between the Sizes of Converged Light and Measures to Deal Therewith

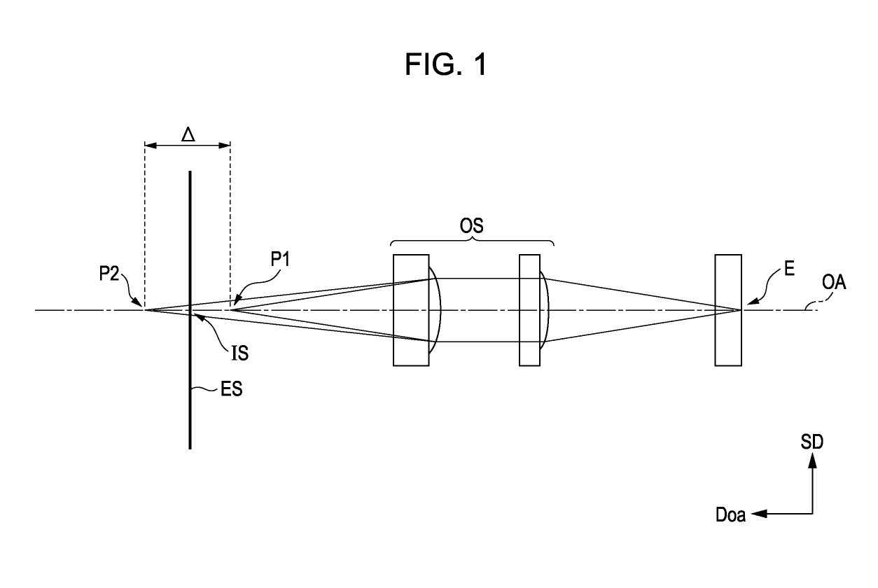

FIG. 1 is a diagram used to describe the cause of a difference between the sizes of converged light and measures to deal therewith. FIG. 1 is a view from a main scanning direction MD, which is perpendicular to a sub-scanning direction SD. In an image forming apparatus according to an embodiment of the invention, an optical system OS is disposed in such a manner that an optical axis OA thereof extends toward an exposure surface ES. The optical system OS converges a light, which is emitted from a light emitting element E, at the vicinity of an intersection point IS at which the optical axis OA intersects the exposure surface ES. With this structure, deviation in the position of the exposure surface ES in an optical axis direction Doa (a direction parallel to the optical axis OA, a first direction) may cause the size of the converged light (spot) formed on the exposure surface ES to deviate.

As measures to deal with such a problem, the following structure can be used. In the structure illustrated in FIG. 1, the light emitting element E emits a light having a wavelength λ1 and a light having a wavelength λ2. The optical system OS focuses the light having the wavelength λ1 at a first imaging position P1 and focuses the light having the wavelength λ2 at a second imaging position P2. As illustrated in the figure, the imaging positions P1 and P2 are separated from each other by a distance Δ in the optical axis direction Doa. By thus making the optical system OS focus the light at different imaging positions P1 and P2, an effect is obtained in that the apparent depth of focus of the optical system OS is increased. Moreover, the exposure surface ES is located between the first imaging position P1 and the second imaging position P2 (in other words, the first imaging position P1 is located on one side of the exposure surface ES and the second imaging position P2 is located on the other side of the exposure surface ES). Therefore, even if the position of the exposure surface ES deviates to some extent, the difference between the sizes of converged light can be suppressed, whereby a good exposure can be realized.

The optical axis of an optical system will be described before describing the embodiments. The optical axis of an optical system can be obtained as follows. When an optical system is symmetric (mirror symmetric) with respect to a plane perpendicular to the sub-scanning direction SD (second direction) and symmetric (mirror symmetric) with respect to a plane perpendicular to the main scanning direction MD (third direction), the optical system has a second symmetry plane that is perpendicular to the second direction and has a third symmetry plane that is perpendicular to the third direction. The optical axis can be obtained as the intersection of the first symmetry plane and the second symmetry plane. In particular, if the optical system is rotationally symmetric, the intersection of the second symmetry plane and the third symmetry plane coincides with the axis of rotational symmetry, and the optical axis can be obtained as this axis of rotational symmetry.

### B-1. First Embodiment

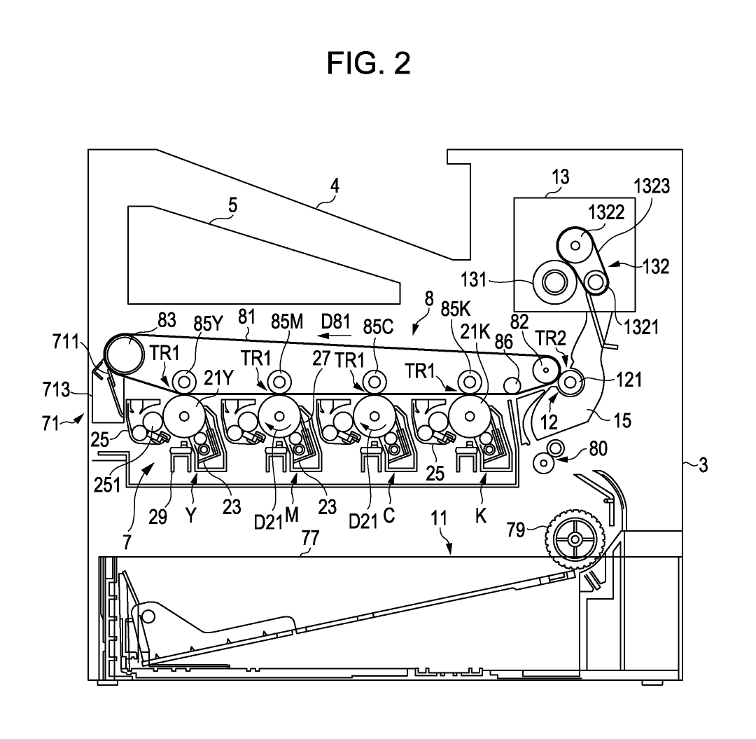

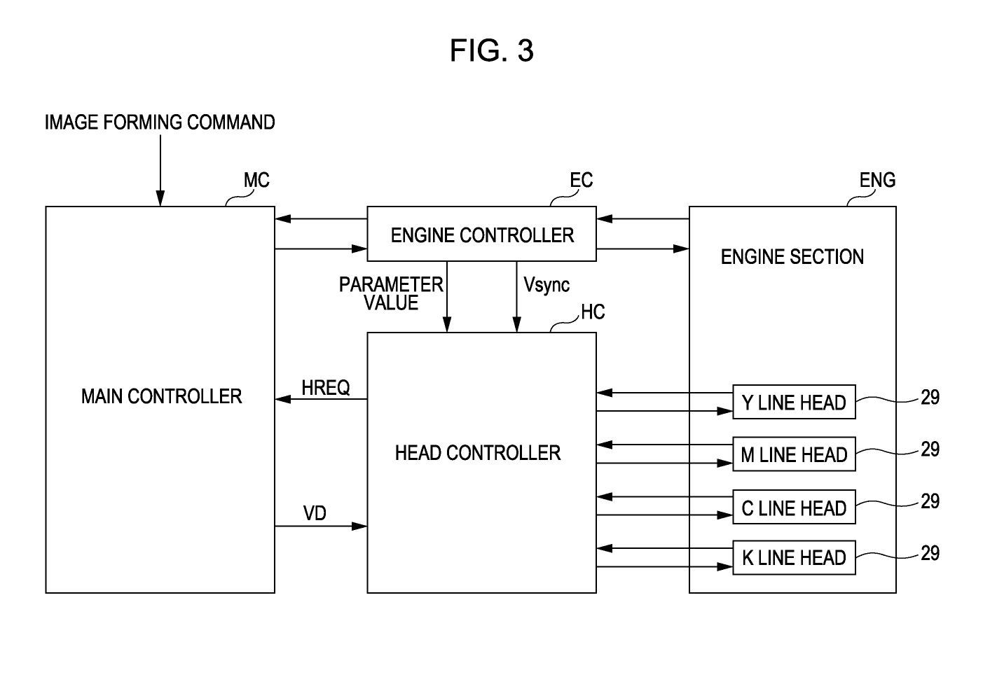

FIG. 2 is a diagram illustrating an example of an image forming apparatus to which the invention can be applied. FIG. 3 is a block diagram of the electrical structure of the image forming apparatus illustrated in FIG. 2. The image forming apparatus can selectively perform a color mode or a monochrome mode. In the color mode, a color image is formed by overlaying toners of four colors: black (K), cyan (C), magenta (M), and yellow (Y). In the monochrome mode, a monochrome image is formed using only the black (K) toner. FIG. 2 illustrates the image forming apparatus when performing the color mode. In the image forming apparatus, when an image forming command is supplied by an external apparatus such as a host computer to a main controller MC, which includes a CPU and a memory, the main controller MC supplies a control signal and the like to an engine controller EC and supplies video data VD corresponding to the image forming command to a head controller HC. At this time, the main controller MC supplies the head controller HC with the video data VD for one line extending in the main scanning direction MD every time the main controller MC receives a horizontal request signal HREQ from the head controller HC. The head controller HC controls line heads 29 for the four colors on the basis of the video data VD, which is supplied by the main controller MC, a vertical synchronizing signal Vsync, which is supplied by the engine controller EC, and a parameter value. Thus, an engine section ENG performs a predetermined image forming operation, so that an image corresponding to the image forming command is formed on a sheet of tracing paper, transfer paper, form, or OHP transparency.

An electrical component box 5, which is disposed in a housing body 3 of the image forming apparatus, contains a power circuit substrate, the main controller MC, the engine controller EC, and the head controller HC. An image forming unit 7, a transfer belt unit 8, and a sheet feed unit 11 are disposed in the housing body 3. A secondary transfer unit 12, a fixing unit 13, and a sheet guide 15 are disposed on the right side of the housing body 3 in FIG. 2. The sheet feed unit 11 is removably attached to an apparatus body 1. The sheet feed unit 11 and the transfer belt unit 8 can be removed for repair or for replacement.

The image forming unit 7 includes four image forming stations Y (yellow), M (magenta), C (cyan), and K (black), each forming an image of a corresponding color. Each of the image forming stations Y, M, C, and K includes a photosensitive drum 21 having a cylindrical shape and having a surface with a predetermined length in the main scanning direction MD. Each of the image forming stations Y, M, C, and K forms a toner image of a corresponding color on the surface of the photosensitive drum 21. The photosensitive drums 21 is disposed in such a manner that the axis thereof extends in a direction parallel to or substantially parallel to the main scanning direction MD. Each of the photosensitive drums 21 is connected to a dedicated drive motor that rotates the photosensitive drum 21 at a predetermined speed in a direction indicated by an arrow D21 in FIG. 2. Thus, the surface of the photosensitive drum 21 is moved in the sub-scanning direction SD that is perpendicular to or substantially perpendicular to the main scanning direction MD. Around the photosensitive drum 21, a charger 23, the line head 29, a developing section 25, and a photosensitive-body cleaner 27 are arranged in the rotation direction. These operation sections perform charging, forming of a latent image, and developing of toner. In the color mode, a color image is formed by overlaying toner images, which have been formed by the image forming stations Y, M, C, and K, on a transfer belt 81 included in the transfer belt unit 8. In the monochrome mode, a monochrome image is formed with a toner image formed by the image forming station K. In FIG. 2, for convenience of drawing, numerals are attached to only some of the image forming stations and omitted for the rest, because the image forming stations of the image forming unit 7 have the same structure.

The charger 23 includes a charging roller having a surface made of elastic rubber. The charging roller rotates while being in contact with the surface of the photosensitive drum 21 at a charging position. As the photosensitive drum 21 rotates, the charging roller is rotated by the photosensitive drum 21 in a driven direction at a peripheral speed. The charging roller is connected to a charge bias generator (not shown). The charging roller, which is supplied with a charge bias from the bias generator, charges the surface of the photosensitive drum 21 at the charging position at which the charger 23 contacts the photosensitive drum 21.

The line head 29 is disposed at a distance from the photosensitive drum 21. The longitudinal direction of the line head 29 is parallel to or substantially parallel to the main scanning direction MD. The lateral direction of the line head 29 is parallel to or substantially parallel to the sub-scanning direction SD. The line head 29 includes a plurality of light emitting elements, and each of the light emitting elements emits a light in accordance with the video data VD supplied by the head controller HC. The charged surface of the photosensitive drum 21 is irradiated with the light emitted from the light emitting elements, whereby an electrostatic latent image is formed on the surface of the photosensitive drum 21.

The developing section 25 includes a development roller 251 having a surface for bearing toner thereon. The development roller 251 is electrically connected to a development bias generator (not shown) that applies a development bias to the development roller 251. The developing bias moves the charged toner from the development roller 251 to the photosensitive drum 21 at the development position at which the development roller 251 contacts the photosensitive drum 21. Thus, the electrostatic latent image, which has been formed by the line head 29, is developed.

The toner image, which has been developed at the development position, is transported in the rotation direction D21 of the photosensitive drum 21. Subsequently, the toner image is primarily transferred to the transfer belt 81 at a primary transfer position TR1 at which the transfer belt 81 contacts the photosensitive drum 21.

In the embodiment, the photosensitive-body cleaner 27, which contacts the surface of the photosensitive drum 21, is disposed downstream of the primary transfer position TR1 and upstream of the charger 23 with respect to the rotation direction D21 of the photosensitive drum 21. The photosensitive-body cleaner 27 contacts the surface of the photosensitive drum 21 and removes residual toner remaining on the surface of the photosensitive drum 21 after the primary transfer.

The transfer belt unit 8 includes a drive roller 82, a driven roller 83 (blade facing roller), which is disposed on the left side of the drive roller 82 in FIG. 2, and the transfer belt 81, which is looped over the drive roller 82 and the driven roller 83 and rotated in a direction (transport direction) indicated by an arrow D81 in FIG. 2. The transfer belt unit 8 includes four primary transfer rollers 85Y, 85M, 85C, and 85K disposed on the inner side of the transfer belt 81. The primary transfer rollers 85Y, 85M, 85C, and 85K respectively face the photosensitive drums 21 of the image forming stations Y, M, C, and K when the photosensitive cartridge is mounted. Each of the primary transfer rollers 85 is electrically connected to a primary transfer bias generator (not shown). As illustrated in FIG. 2, in the color mode, all primary transfer rollers 85Y, 85M, 85C, and 85K are located adjacent to the image forming stations Y, M, C, and K, so that the transfer belt 81 is pressed against the photosensitive drums 21 of the image forming stations Y, M, C, and K. Thus, the primary transfer position TR1 is formed between each of the photosensitive drum 21 and the transfer belt 81. The primary transfer bias generator applies a primary transfer bias to the primary transfer roller 85 at an appropriate time, so that a toner image formed on the surface of each photosensitive drum 21 is transferred to the transfer belt 81 at the corresponding primary transfer position TR1. As a result, a color image is formed.

On the other hand, in the monochrome mode, the color primary transfer rollers 85Y, 85M, and 85C are separated from the image forming stations Y, M, and C respectively facing them. Only the monochrome primary transfer roller 85K located adjacent to the image forming station K, so that only the monochrome image forming station K contacts the transfer belt 81. As a result, the primary transfer position TR1 is formed only between the monochrome primary transfer roller 85K and the image forming station K. The primary transfer bias generator applies a primary transfer bias to the primary transfer roller 85K at an appropriate time, so that a toner image formed on the surface of a photosensitive drum 21K is transferred to the transfer belt 81 at the primary transfer position TR1. As a result, a monochrome image is formed.

The transfer belt unit 8 includes a downstream guide roller 86 that is disposed downstream of the monochrome primary transfer roller 85K and upstream of the drive roller 82. The downstream guide roller 86 contacts the transfer belt 81 at a position on an internal common tangent line formed by the monochrome primary transfer roller 85K and the photosensitive drum 21K of the image forming station K at the primary transfer position TR1 at which the monochrome primary transfer roller 85K and the photosensitive drum 21K contact each other.

The drive roller 82 rotates the transfer belt 81 in the direction indicated by the arrow D81 and also serves as a backup roller of a secondary transfer roller 121. The peripheral surface of the drive roller 82 is covered with a rubber layer having a thickness of about 3 mm and a volume resistivity lower than 1000 kΩcm. The rubber layer is grounded through a metal shaft and serves as a conductive path of a secondary transfer bias that is supplied by the secondary transfer bias generator (not shown) through the secondary transfer roller 121. By forming the rubber layer, which has high friction and shock absorption, on the drive roller 82, transmission of an impact that occurs when a sheet enters a contact portion (secondary transfer position TR2) between the drive roller 82 and the secondary transfer roller 121 to the transfer belt 81 is suppressed, whereby degradation of the quality of an image can be prevented.

The sheet feed unit 11 includes a sheet feed cassette 77, which can hold a stack of sheets, and a sheet feed section that includes a pickup roller 79 that feeds the sheets one by one from the sheet feed cassette 77. When a sheet is fed from the sheet feed section by the pickup roller 79, a pair of registration rollers 80 adjust timing to feed the sheet, and the sheet is fed to the secondary transfer position TR2 along the sheet guide 15.

The secondary transfer roller 121 can be made to contact or to be separated from the transfer belt 81, driven by a secondary transfer roller drive mechanism (not shown). The fixing unit 13 includes a heating roller 131 and a pressure section 132. The heating roller 131 is rotatable and includes a heating element such as a halogen heater. The pressure section 132 presses and urges the heating roller 131. The sheet guide 15 guides the sheet, on which an image has been secondarily transferred, to a nip portion formed between the heating roller 131 and a pressure belt 1323 of the pressure section 132. An image is thermally fixed at the nip portion at a predetermined temperature. The pressure section 132 includes two rollers 1321 and 1322 and the pressure belt 1323 looped over the two rollers. A surface of the pressure belt 1323 extending between the rollers 1321 and 1322 is pressed against the peripheral surface of the heating roller 131 so as to enlarge the nip portion between the heating roller 131 and the pressure belt 1323. The sheet, that has been subjected the fixing operation, is transported to an output tray 4 disposed on an upper surface of the housing body 3.

This apparatus includes a cleaner section 71 that faces the blade facing roller 83. The cleaner section 71 includes a cleaner blade 711 and a waste toner box 713. An edge of the cleaner blade 711 contacts the blade facing roller 83 with the transfer belt 81 therebetween so as to remove foreign substances, such as residual toner and paper dust, which remain on the transfer belt 81 after the secondary transfer. The foreign substances that have been removed are recovered in the waste toner box 713.

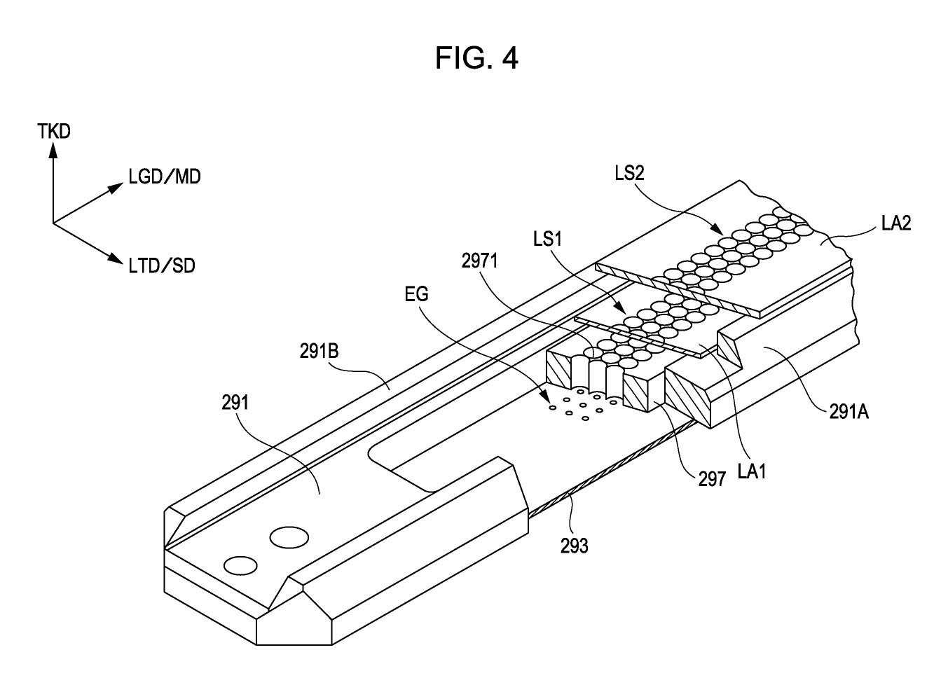

FIG. 4 is a schematic perspective view of a line head. In FIG. 4, a part of the line head 29 is illustrated in a cross section in order to facilitate understanding of the structure of the line head 29 in the thickness direction TKD. The thickness direction TKD is perpendicular to or substantially perpendicular to the longitudinal direction LGD and the lateral direction LTD. Light emitting elements E (described below) emit light in the thickness direction TKD (that is, from the line head 29 toward the photosensitive drum 21). The line head 29 includes a head frame 291 extending in the longitudinal direction LGD. A first lens array LA1 and a second lens array LA2 are supported on one side of the head frame 291 in the thickness direction TKD. A head substrate 293 is supported on the other side of the head frame 291 in the thickness direction TKD. A light blocking member 297 is disposed in the head frame 291. Thus, the line head 29 includes the head substrate 293, the light blocking member 297, the first lens array LA1, and the second lens array LA2 that are arranged in this order in the thickness direction TKD. Referring to FIGS. 4 to 6, details of the components will be described. In the description of the embodiment, the downstream side with respect to the thickness direction TKD (the upper side in FIG. 4) is referred to as a “first side (with respect to the thickness direction TKD)” and the upstream side with respect to the thickness direction TKD (the lower side in FIG. 4) is referred to as a “second side (with respect to the thickness direction TKD)” A surface on the first side of a substrate or a plate is referred to as a front surface, and a surface on the second side of the substrate or the plate is referred to as a back surface.

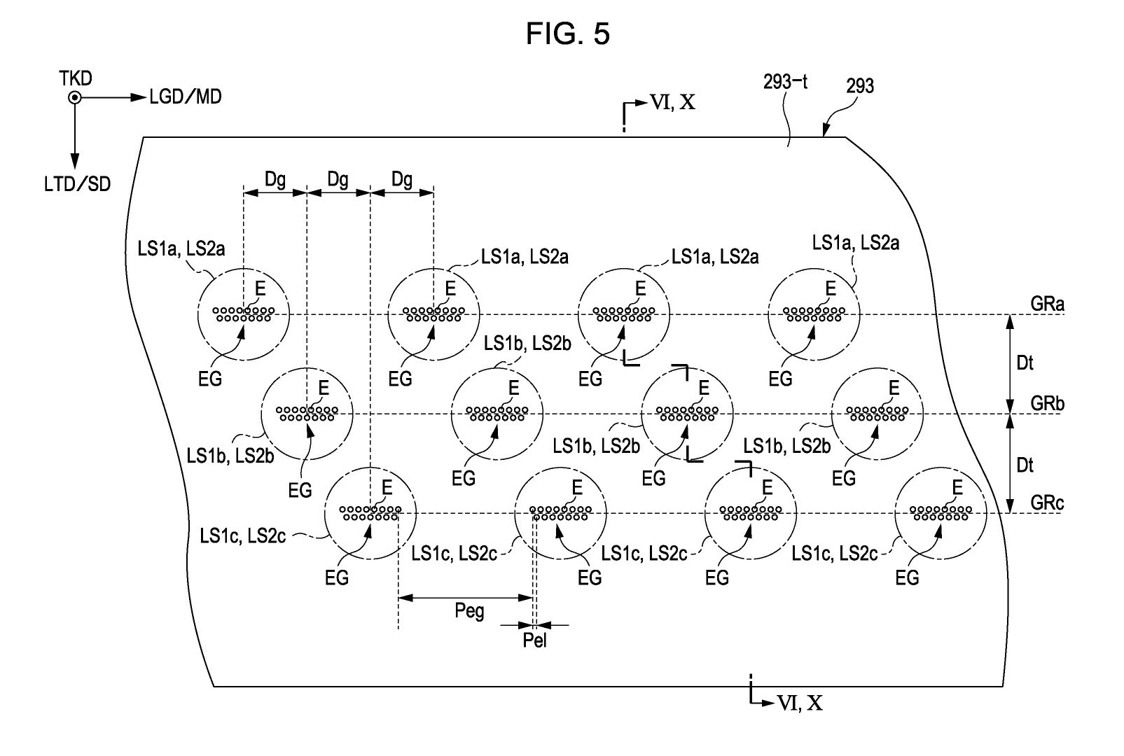

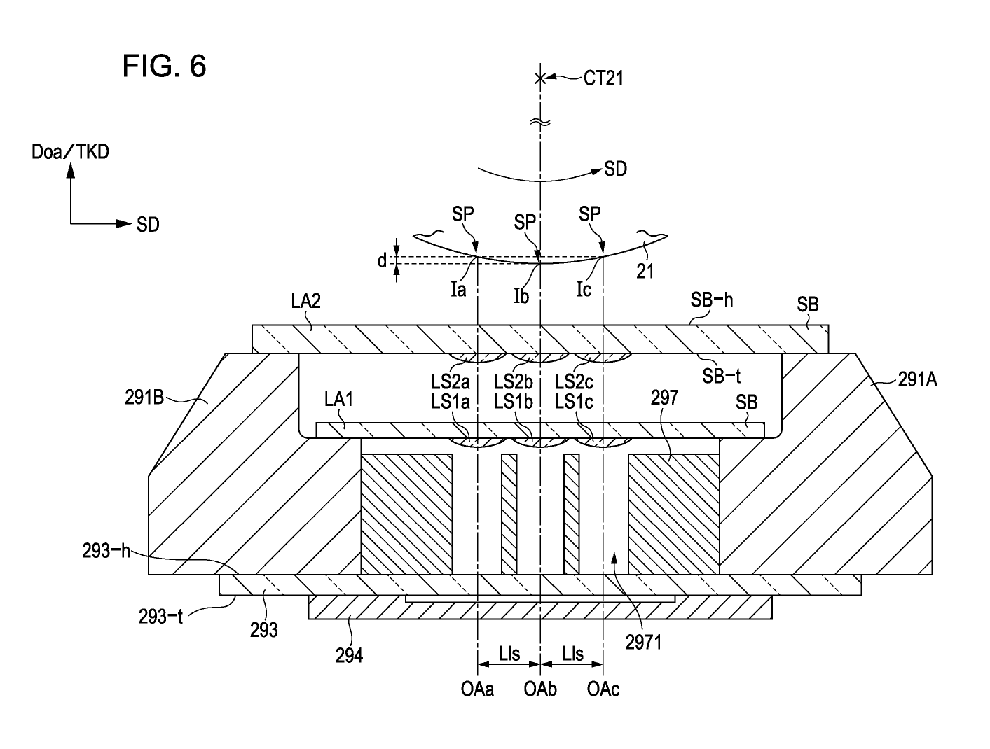

FIG. 5 is a partial plan view of the head substrate 293 viewed from the thickness direction TKD. FIG. 5 illustrates a head-substrate back surface 293-t seen through the head substrate 293 from the downstream side (the upper side in FIG. 4) with respect to the thickness direction TKD. FIG. 6 is a stepped sectional view of the line head of the first embodiment taken along line VI,X-VI,X of FIG. 5, viewed from the longitudinal direction LGD (main scanning direction MD).

FIG. 5 also illustrates, with alternate long and short dash lines, first lenses LS1a, LS1b, and LS1c (represented by a numeral LS1 in FIG. 4), which are formed in the first lens array LA1, and second lenses LS2a, LS2b, and LS2c (represented by a numeral LS2 in FIG. 4), which are formed in the second lens array LA2, in order to illustrate the positional relationship between light emitting element groups EG, which are formed in the head substrate 293, the first lenses LS1a, LS1b, and LS1c, and the second lenses LS2a, LS2b, and LS2c. The reason for illustrating the first lenses LS1a, LS1b, and LS1c and the second lenses LS2a, LS2b, and LS2c in FIG. 5 is to indicate the positional relationship therebetween, and not to indicate that the first lenses LS1a, LS1b, and LS1c and the second lenses LS2a, LS2b, and LS2c are formed on the head-substrate back surface 293-t (FIG. 6).

The head substrate 293 is formed of a glass substrate that transmits light. A plurality of light emitting elements E, which are bottom emission organic EL (Electro-Luminescence) devices, are formed on the head-substrate back surface 293-t and sealed with a sealing member 294 (FIG. 6). The plurality of light emitting elements E have the same emission spectrum and emit light toward the surface of the photosensitive drum 21. As illustrated in FIG. 5, the plurality of light emitting elements E, which are arranged on the head-substrate back surface 293-t, are divided into groups. That is, one light emitting element group EG is constituted by fifteen light emitting elements E that are arranged in the longitudinal direction LGD in two lines in a staggered manner. Moreover, a plurality of light emitting element groups EG are arranged in the longitudinal direction LGD in three lines in a separately staggered manner.

In further detail, this arrangement can be described as follows. In each light emitting element group EG, fifteen light emitting elements E are disposed at different positions with respect to the longitudinal direction LGD. The distance between the light emitting elements E that are adjacent to each other in the longitudinal direction LGD is an inter-element pitch Pel (in other words, in each light emitting element group EG, fifteen light emitting elements E are arranged at the pitch Pel in the longitudinal direction LGD). The plurality of light emitting element groups EG are separately arranged in the longitudinal direction LGD at an inter-group pitch Peg, which is larger than the inter-element pitch Pel, thereby forming the light emitting element group line GRa. Three light emitting element group lines GRa, GRb, and GRc are separately disposed with a distance Dt therebetween in the lateral direction LTD. Moreover, the light emitting element group lines GRa, GRb, and GRc are shifted from each other by a distance Dg in the longitudinal direction LGD.

The inter-element pitch Pel can be obtained as the distance between the geometric barycenters of two light emitting elements E that are adjacent to each other in the longitudinal direction LGD. The inter-group pitch Peg can be obtained as the distance, in the longitudinal direction LGD, between the geometric barycenter of a light emitting element E that is at a front end of the light emitting element group EG with respect to the longitudinal direction LGD and the geometric barycenter of a light emitting element E that is at a back end of an adjacent light emitting element group EG with respect to the longitudinal direction LGD. The distance Dg can be obtained as the distance between the geometric barycenters of two light emitting element groups EG that are adjacent to each other in the longitudinal direction LGD. The distance Dt can be obtained as the distance between the geometric barycenters of two light emitting element groups EG that are adjacent to each other in the lateral direction LTD.

Thus, the plurality of light emitting element groups EG are separately arranged on the head-substrate back surface 293-t. On the other hand, a head-substrate front surface 293-h is attached to the second side of the head frame 291 with respect to the thickness direction TKD with an adhesive. The head-substrate front surface 293-h is in contact with the light blocking member 297 disposed in the head frame 291. A second side of the light blocking member 297 with respect to the thickness direction TKD is attached to the head-substrate front surface 293-h with an adhesive. Light guide holes 2971 extend through the light blocking member 297 in the thickness direction TKD. The light guide holes 2971 are circular in plan view when viewed from the thickness direction TKD, and the inner walls thereof are black plated. Each of the light guide holes 2971 corresponds to one of the light emitting element groups EG. That is, one light guide hole 2971 is formed for one light emitting element group EG. Thus, the light blocking member 297 is attached to the head-substrate front surface 293-h in such a manner that the light guide hole 2971 is open toward the light emitting element group EG.

The light blocking member 297 is provided in order to prevent so-called stray light from entering the lenses LS1 and LS2. Each of the light emitting element groups EG includes a dedicated optical system constituted by a pair of the lenses LS1 and LS2. When using such a structure, it is desirable that a light enter only the optical system constituted by LS1 and LS2 of the light emitting element group EG that is an emission source thereof and be focused. However, a part of the light may not enter the optical system constituted by LS1 and LS2 of the light emitting element group EG that is the emission source thereof. This part of the light becomes stray light. If such stray light enters the optical system constituted by LS1 and LS2 of the light emitting element group EG that is not the emission source thereof, a so-called ghost may be generated. In order to prevent this, in the embodiment, the light blocking member 297 is disposed between the light emitting element group EG and the optical system constituted by LS1 and LS2. The light blocking member 297 has the light guide hole 2971 that has a black-plated inner wall and that is open toward the light emitting element group EG. Therefore, most of the stray light is absorbed by the inner wall of the light guide hole 2971. As a result, ghost is suppressed and a good exposure operation can be realized.

On a first side of the light blocking member 297 with respect to the thickness direction TKD, a first lens array LA1, which is substantially flat-plate shaped, is supported between side portions 291A and 291B of the head frame 291 in the lateral direction LTD. On the back surface of the first lens array LA1, the first lenses LS1 (LS1a, LS1b, and LS1c) are formed so as to correspond to the light emitting element groups EG. That is, one first lens LS1 faces one light emitting element group EG. Thus, in the first lens array LA1, a plurality of first lenses LS1 are arranged in three lines in a staggered manner. In other words, three first lenses LS1 (LS1a, LS1b, and LS1c) that are disposed adjacent to each other in the main scanning direction MD (longitudinal direction LGD) are disposed at different positions with respect to the sub-scanning direction SD (lateral direction LTD). In FIGS. 5 and 6, the first lenses LS1 are illustrated differently in accordance with their positions with respect to the sub-scanning direction SD. That is, the first lens LS1 that is located at the most upstream position with respect to the sub-scanning direction SD is represented by the numeral LS1a, the first lens LS1 that is located in the middle position with respect to the sub-scanning direction SD is represented by the numeral LS1b, and the first lens LS1 that is located at the most downstream position with respect to the sub-scanning direction SD is represented by the numeral LS1c.

On a first side of the first lens array LA1 with respect to the thickness direction TKD, a second lens array LA2, which is substantially flat-plate shaped, is supported between the side portions 291A and 291B in the lateral direction LTD of the head frame 291. On the back surface of the second lens array LA2, the second lenses LS2 (LS2a, LS2b, and LS2c) are formed so as to correspond to the light emitting element groups EG. That is, one second lens LS2 faces one light emitting element group EG. Thus, in the second lens array LA2, a plurality of second lenses LS2 are arranged in three lines in a staggered manner. In other words, the second lenses LS2 (LS2a, LS2b, and LS2c) that are disposed adjacent to each other in the main scanning direction MD (longitudinal direction LGD) are disposed at different positions with respect to the sub-scanning direction SD (lateral direction LTD). In FIGS. 5 and 6, the second lenses LS2 are illustrated differently in accordance with their positions with respect to the sub-scanning direction SD. That is, the second lens LS2 that is located at the most upstream position with respect to the sub-scanning direction SD is represented by the numeral LS2a, the second lens LS2 that is located in the middle position with respect to the sub-scanning direction SD is represented by the numeral LS2b, and the second lens LS2 that is located at the most downstream position with respect to the sub-scanning direction SD is represented by the numeral LS2c.

Each of the lens arrays LA1 and LA2 includes a light-transmissive lens array substrate SB made of glass. The lenses LS1 and LS2, which are made of resin, are formed on a back surface SB-t of the lens array substrate SB. That is, the first lenses LS1 (LS1a, LS1b, and LS1c), which are made of resin, are formed on the back surface of the substrate SB of the first lens array LA1 (in the same plane). The second lenses LS2 (LS2a, LS2b, and LS2c), which are made of resin, are formed on the back surface of the substrate SB of the second lens array LA2. The lens arrays LA1 and LA2 can be formed by using an existing method, such as a method of using a metal mold. With this method, a metal mold having concave portions corresponding to the shapes of the lenses LS1 and LS2 is made to contact the back surface SB-t of the lens array substrate SB, and a photo-curable resin is injected into a space between the metal mold and the lens array substrate SB. Subsequently, the photo-curable resin is irradiated with light so that the resin is cured, thereby forming the lenses LS1 and LS2 on the lens array substrate SB.

Thus, three optical systems, that is, the upstream optical system constituted by LS1a and LS2a, the middle optical system constituted by LS1b and LS2b, and the downstream optical system constituted by LS1c and LS2c are disposed at different positions with respect to the sub-scanning direction SD. The optical axes OAa, OAb, and OAc of the three optical systems (such as that constituted by LS1a and LS2a) are parallel to each other, and parallel to the optical axis direction Doa illustrated in FIG. 6 and other figures. The optical axis direction Doa is parallel to the optical axes OAa, OAb, and OAc, parallel to the direction in which the light emitting elements E emit light, and parallel to the thickness direction TKD. The distance between the upstream optical system constituted by LS1a and LS2a and the middle optical system constituted by LS1b and LS2b and the distance between the middle optical system constituted by LS1b and LS2b and the downstream optical system constituted by LS1c and LS2c in the sub-scanning direction SD are the same distance Lls. The distances between the optical systems (such as that constituted by LS1a and LS2a) can be obtained as the distances between the optical axes OAa, OAb, and OAc.

The surface (peripheral surface) of the photosensitive drum 21 has a finite curvature. The optical axis OAb of the middle optical system passes through the center of curvature CT21 of the photosensitive drum 21. The optical axis OAa of the upstream optical system constituted by LS1a and LS2a and the optical axis OAc of the downstream optical system constituted by LS1c and LS2c are located on lateral sides of the optical axis OAb of the middle optical system at a distance Lls in the sub-scanning direction SD. As a result, an intersection point Ib, at which the optical axis OAb of the middle optical system intersects the peripheral surface of the photosensitive drum 21, is displaced from the intersection point Ia, at which the optical axis OAa of the upstream optical system intersects the peripheral surface of the photosensitive drum 21, and from the intersection point Ic, at which the optical axis OAc of the downstream optical system intersects the peripheral surface of the photosensitive drum 21, by a distance d in the optical axis direction Doa.

Each of the upstream optical system constituted by LS1a and LS2a, the middle optical system constituted by LS1b and LS2b, and the downstream optical system constituted by LS1c and LS2c converges a light emitted from the light emitting element E on the peripheral surface of the photosensitive drum 21. These optical systems converge light at the vicinities of intersection points 1a, 1b, and Ic of the peripheral surface of the photosensitive drum 21 and the optical axes OAa, OAb, and OAc, respectively (FIG. 6), thereby forming converged light (spots SP) at different positions with respect to the sub-scanning direction SD. Each of the optical systems in the embodiment forms an inverted reduced image. The magnification is a negative value whose absolute value is smaller than 1.

The cross-sectional shape of the photosensitive drum 21 is not a perfect circle and is uneven within tolerance. As a result, the position of the surface of the photosensitive drum 21 deviates relative to the line head 29, so that the sizes of the converged light formed on the surface of the photosensitive drum 21 may deviate.

In order to prevent this, in the embodiment, the apparent depths of focus of the optical systems are increased. That is, in the embodiment, the light emitting elements E have an emission spectrum having peaks at wavelengths λ1 and λ2. Each of the upstream optical system constituted by LS1a and LS2a, the middle optical system constituted by LS1b and LS2b, and the downstream optical system constituted by LS1c and LS2c focuses a light having the wavelength λ1 and a light having the wavelength λ2 at different positions with respect to the optical axis direction Doa. As the light emitting element E, for example, an organic EL device described in JP-A-10-237439 can be used. To be specific, the organic EL device has an emission spectrum having peaks at wavelengths of 463 nm and 534 nm.

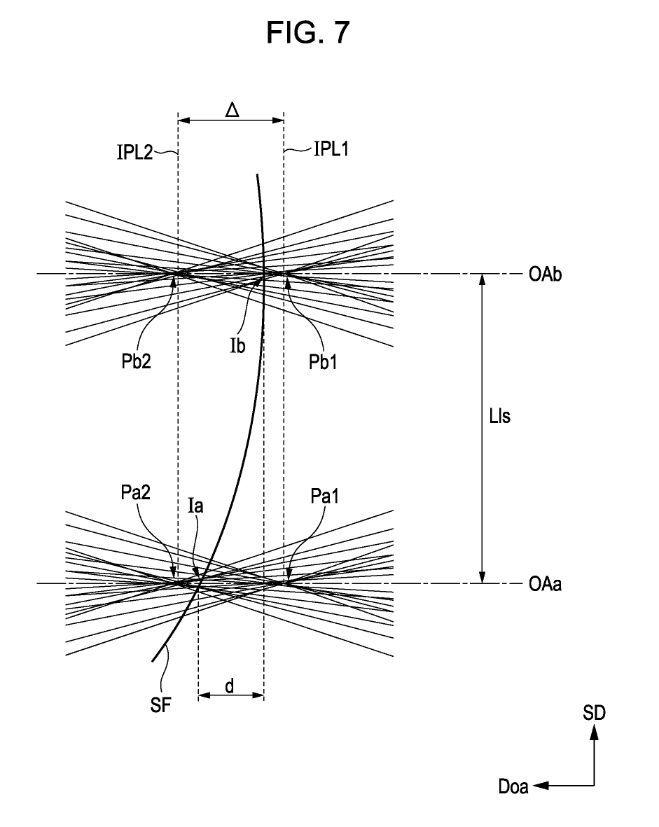

FIG. 7 is a diagram used to describe an imaging operation performed by the optical system in the first embodiment, viewed from the main scanning direction MD. In FIG. 7, an imaging operation performed by the downstream optical system is omitted, because the imaging operation performed by the downstream optical system is the same as the imaging operation performed by the upstream optical system. In FIG. 7, the optical system is not illustrated except for the optical axis in order to magnify the vicinity of the imaging position.

As illustrated in FIG. 7, the upstream optical system constituted by LS1a and LS2a focuses a light having the wavelength λ1 at the imaging position Pa1 and focuses a light having the wavelength λ2 at the imaging position Pa2 that is separated from the imaging position Pa1 by a distance Δ in the optical axis direction Doa. Thus, an effect is obtained in that the apparent depth of focus of the upstream optical system constituted by LS1a and LS2a is increased. The middle optical system constituted by LS1b and LS2b focuses a light having the wavelength λ1 at the imaging position Pb1 and focuses a light having the wavelength λ2 at the imaging position Pb2 that is separated from the imaging position Pb1 by a distance Δ in the optical axis direction Doa. Thus, an effect is obtained in that the apparent depth of focus of the middle optical system constituted by LS1b and LS2b is increased.

The upstream optical system constituted by LS1a and LS2a and the middle optical system constituted by LS1b and LS2b have the same optical structure. Therefore, the imaging positions Pa1 and Pb1 are the same in the optical axis direction Doa, and the imaging position Pa2 and Pb2 are the same in the optical axis direction Doa. Therefore, the imaging positions Pa1 and Pb1 are in a first imaging plane IPL1 that is perpendicular to the optical axis direction Doa, and the imaging positions Pa2 and Pb2 are in a second imaging plane IPL2 that is perpendicular to the optical axis direction Doa. The distance between the first imaging plane IPL1 and the second imaging plane IPL2 is the distance Δ. The distance Δ is equal to or larger than the distance d, which is the distance between the intersection point Ia and the intersection point Ib in the optical axis direction Doa. Both the intersection points Ia and Ib are located between the first imaging plane IPL1 and the second imaging plane IPL2. In other words, the surface SF of the photosensitive drum 21 is located between the imaging position Pa1 and the imaging position Pa2 and between the imaging position Pb1 and the imaging position Pb2.

Thus, in the first embodiment, the light emitting element E emits a light having the wavelength λ1 and a light having the wavelength λ2. The optical system constituted by LS1a and LS2a, for example, focuses the light having the wavelengths λ1 and the light having the wavelength λ2 at imaging positions Pa1 and Pa2 that are separated from each other by the distance Δ in the optical axis direction Doa. Thus, an effect is obtained in that the apparent depth of focus of the optical system constituted by LS1a and LS2a is increased. Moreover, the surface SF of the photosensitive drum 21 is located between the imaging positions Pa1 and Pa2. Therefore, for the same reason that is described in the section “A. Cause of Difference between the Sizes of Converged Light and Measures to deal therewith”, variation of the size of the spot SP is suppressed even if the position of the exposure surface ES deviates to some extent, whereby a good exposure can be realized.

In the first embodiment, the light emitting element E has an emission spectrum having peaks at the wavelengths λ1 and λ2. Thus, the apparent depth of focus is effectively increased, whereby a better exposure can be realized.

### B-2. Second Embodiment

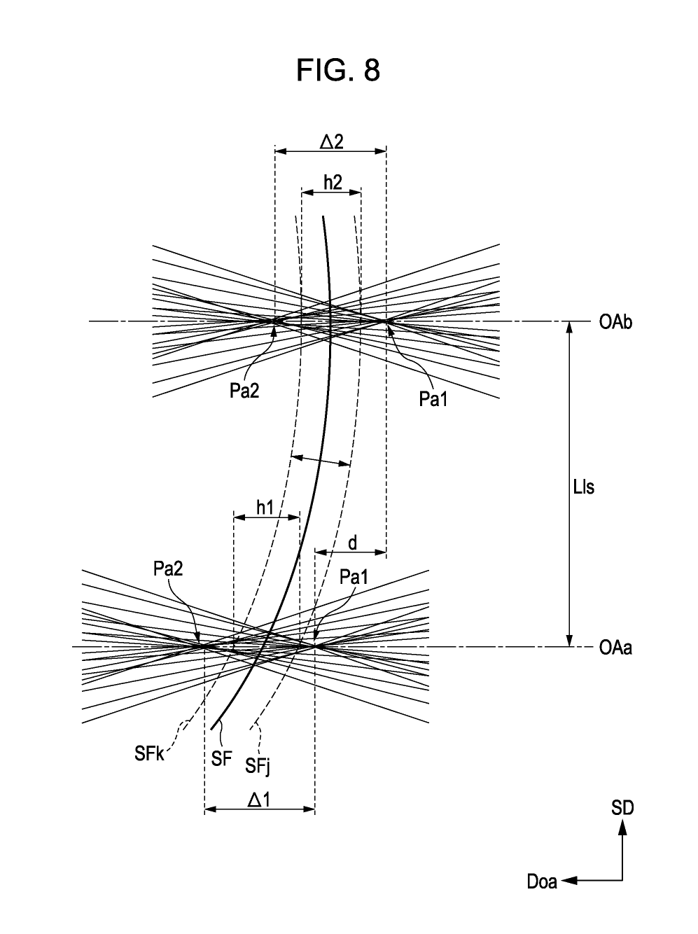

With the structure described above, the position of the spot formed by the upstream optical system constituted by LS1a and LS2a (the vicinity of the intersection point ISa) and the position of the spot formed by the middle optical system constituted by LS1b and LS2b (the vicinity of the intersection point ISb) are displaced from each other by about the distance d in the optical axis direction Doa. Likewise, the position of the spot formed by the downstream optical system constituted by LS1c and LS2c (the vicinity of the intersection point ISc) and the position of the spot formed by the middle optical system constituted by LS1b and LS2b (the vicinity of the intersection point ISb) are displaced from each other by about the distance d in the optical axis direction Doa. In such a case, the size of the spot formed by the upstream optical system constituted by LS1a and LS2a and the size of the spot formed by the middle optical system constituted by LS1b and LS2b may become different. Likewise, the size of the spot formed by the downstream optical system constituted by LS1c and LS2c and the size of the spot formed by the middle optical system constituted by LS1b and LS2b may become different. Thus, the optical systems may be configured as illustrated in FIG. 8.

FIG. 8 is a diagram used to describe an imaging operation performed by the optical system in the second embodiment, viewed from the main scanning direction MD. In FIG. 8, illustration of an imaging operation performed by the downstream optical system is omitted, because the imaging operation performed by the downstream optical system is the same as the imaging operation performed by the upstream optical system. In FIG. 8, the optical system is not illustrated except for the optical axis in order to magnify the vicinity of the imaging position.

As illustrated in FIG. 8, in the second embodiment, the imaging position Pa1 of the upstream optical system constituted by LS1a and LS2a and the imaging position Pb1 of the middle optical system constituted by LS1b and LS2b are shifted (separated) from each other by the distance d in the optical axis direction Doa. The same applies to the relationship between the downstream optical system constituted by LS1c and LS2c and the middle optical system constituted by LS1b and LS2b. That is, the imaging positions are shifted by the distance d, so that the difference between the sizes of the spots is suppressed.

In the image forming apparatus, the surface (peripheral surface) of the photosensitive drum 21 having a cylindrical shape is exposed with the line head 29 while the photosensitive drum 21 rotates. With this structure, the position of a part of the surface SF of the photosensitive drum 21 facing the line head 29 may periodically vary. As a result, the sizes of the light converged onto the surface of the photosensitive drum 21 (converged light) may change in accordance with the movement of the surface SF of the photosensitive drum 21. The second embodiment effectively suppresses this phenomenon. This will be described below.

In the example illustrated in FIG. 8, the position of the surface SF of the photosensitive drum 21 periodically varies between the surface position SFk and the surface position SFj. In order to cope with such positional variation of the surface SF of the photosensitive drum 21, the optical systems have the following structures. That is, as illustrated in FIG. 8, the upstream optical system constituted by LS1a and LS2a focuses a light having the wavelength λ1 at the imaging position Pa1 and focuses a light having the wavelength λ2 at the imaging position Pa2 that is separated from the imaging position Pa1 by a distance Δ in the optical axis direction Doa. Thus, an effect is obtained in that the apparent depth of focus of the upstream optical system constituted by LS1a and LS2a is increased. The distance Δ1 is equal to or larger than a variation range h1 of the position of the peripheral surface of the photosensitive drum 21 along the optical axis OAa of the upstream optical system constituted by LS1a and LS2a. Thus, the peripheral surface of the photosensitive drum 21 is located between the imaging position Pa1 and the imaging position Pa2 irrespective of the positional variation. Therefore, irrespective of the positional variation of the peripheral surface of the photosensitive drum 21, variation of the size of the spot formed by the upstream optical system constituted by LS1a and LS2a is suppressed, whereby a good exposure can be realized.

The middle optical system constituted by LS1b and LS2b focuses a light having the wavelength λ1 at the imaging position Pb1 and focuses a light having the wavelength λ2 at the imaging position Pb2 that is separated from the imaging position Pb1 by a distance Δ2 in the optical axis direction Doa. Thus, an effect is obtained in that the apparent depth of focus of the middle optical system constituted by LS1b and LS2b is increased. The distance Δ2 is equal to or larger than a variation range h2 of the position of the peripheral surface of the photosensitive drum 21 on the optical axis OAb of the middle optical system constituted by LS1b and LS2b. Thus, the peripheral surface of the photosensitive drum 21 is located between the imaging position Pb1 and the imaging position Pb2 irrespective of the positional variation thereof. Therefore, irrespective of the positional variation of the peripheral surface of the photosensitive drum 21, variation of the size of the spots formed by the middle optical system constituted by LS1b and LS2b is suppressed, whereby a good exposure can be realized.

Since the second embodiment has the structure described above, the surface position SFj and the surface position SFk are located between the imaging position Pa1 and the imaging position Pa2 of the upstream optical system constituted by LS1a and LS2a, and the surface position SFj and the surface position SFk are located between the imaging position Pb1 and the imaging position Pb2 of the middle optical system constituted by LS1b and LS2b. Therefore, a change in the size of the converged light in accordance with the positional variation of the surface SF of the photosensitive drum 21 can be suppressed, whereby a better exposure can be realized.

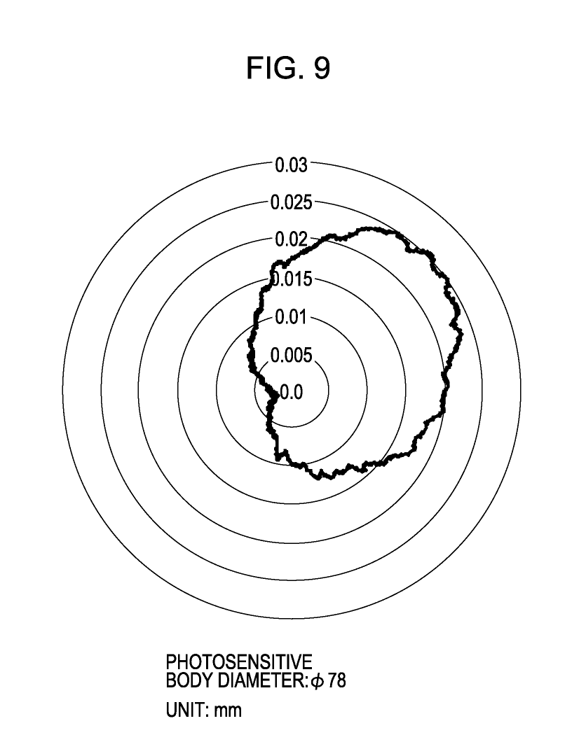

The positional variation of the peripheral surface of the photosensitive drum 21 can be obtained as wobble data of the photosensitive body. FIG. 9 is a diagram illustrating wobble data of the photosensitive body represented by polar coordinates. The wobble data can be obtained as follows. The photosensitive drum 21 is rotated in a state in which a distance sensor faces the surface (peripheral surface) of the photosensitive drum 21. A known sensor can be used as the distance sensor. The distance between the surface of the photosensitive drum 21 and the distance sensor (drum-sensor distance) is obtained for one rotation of the photosensitive drum 21 and stored in a memory. Then, wobble data of the photosensitive body illustrated in FIG. 9 is obtained by plotting variation in the drum-sensor distance (that is, the difference between the drum-sensor distance for each angle and the minimum value of the drum-sensor distance). The maximum value in FIG. 9 is the variation range d21. In the above description, the positional variation of the surface of the photosensitive drum 21 is due to the fact that the cross-sectional shape of the photosensitive drum 21 is not a perfect circle. However, such positional variation may occur when the photosensitive drum 21 is eccentric to the rotation axis.

### B-3. Third Embodiment

The first embodiment has an advantage in that the apparent depth of focus of the optical system is increased, because the optical system is configured to focus light at different imaging positions. However, if the distance Δ between the imaging positions of the optical system in the optical axis direction Doa is too large, the aberration of the converged light (spots) increase and thereby the imaging performance may deteriorate. Therefore, a third embodiment has the following structure, in addition to the structure the same as that of the first embodiment. Needless to say, the third embodiment has the same advantage as that of the first embodiment, because the third embodiment include the structure the same as that of the first embodiment.

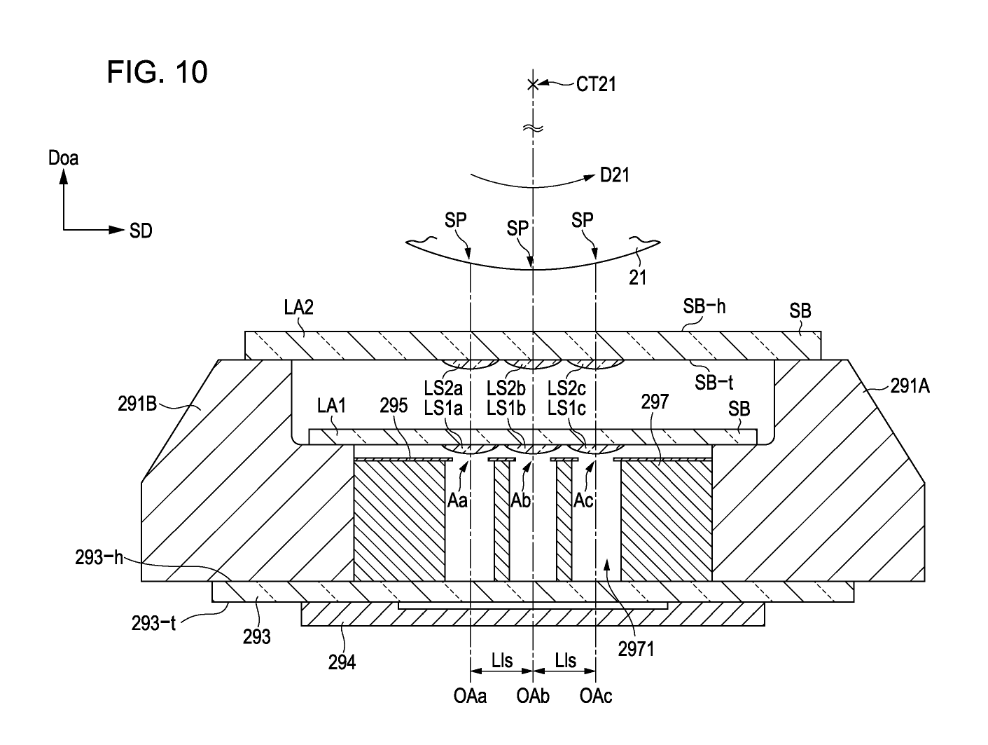

FIG. 10 is a stepped sectional view of a line head of the third embodiment taken along line VI,X-VI,X of FIG. 5, when the cross section is viewed from the longitudinal direction LGD (main scanning direction MD). As illustrated in FIG. 10, the line head of the third embodiment includes a diaphragm plate 295 that is disposed between the first lens array LA1 and the light blocking member 297. Aperture diaphragms Aa, Ab, and Ac, which correspond to the optical systems, are formed in the diaphragm plate 295. The aperture diaphragm Aa limits the amount of light that enters, for example, the optical system constituted by LS1a and LS2a. The third embodiment has the following optical structure including the aperture diaphragms Aa, Ab, and Ac.

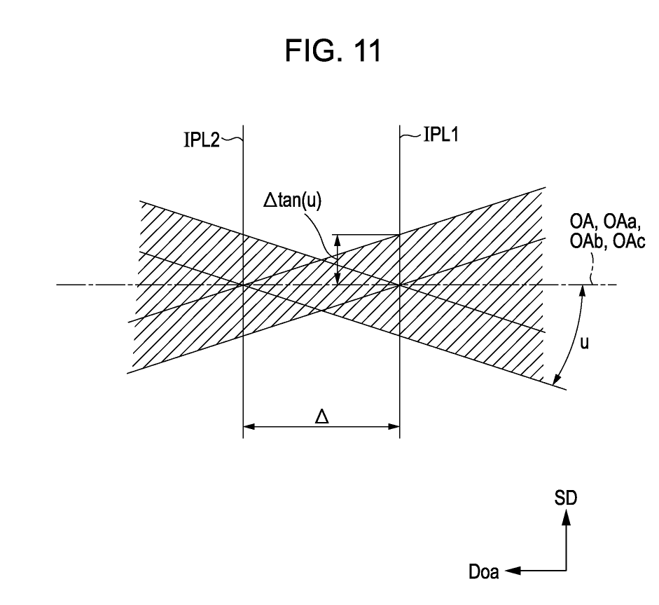

FIG. 11 is a diagram for describing the optical structure of the third embodiment. If the influence of aberration of the light having the wavelength λ2 (second wavelength) in the imaging plane IPL1 of the light having the wavelength λ1 (first wavelength) becomes comparable to the size of an image of a light emitting element on an image surface, the resolution conspicuously decreases. In order to form a fine image, it is desirable that such decrease in the resolution be suppressed. In the third embodiment, an expression

Δ≦|m|×D/tan(u) (expression 1)

is satisfied, where D is a diameter of the light emitting element E with respect to the main scanning direction MD, m is a lateral magnification of the optical system with respect to the main scanning direction MD, and u is an image-side angular aperture that is half the angle between two lines connecting an image point and ends of a diameter of an entrance pupil. Thus, influence on the imaging performance such as aberration is suppressed, so that a better exposure can be realized.

The imaging planes are perpendicular to the optical axis OA. FIG. 11 illustrates the imaging plane IPL1 of the light having the wavelength λ1 and the imaging plane IPL2 of the light having the wavelength λ2.

### C. Modifications

In the embodiments, the line head 29 corresponds to the “exposure head” of the invention, the photosensitive drum 21 corresponds to the “image carrier” of the invention, and the surface SF of the photosensitive drum 21 corresponds to the “surface of the image carrier” of the invention. In the first embodiment, for example, the wavelength λ1 corresponds to the “first wavelength” or the “third wavelength” of the invention, the wavelength λ2 corresponds to the “second wavelength” or the “fourth wavelength” of the invention, the imaging position Pa1 corresponds to the “first imaging position” of the invention, the imaging position Pa2 corresponds to the “second imaging position” of the invention, the imaging position Pb1 corresponds to the “third imaging position” of the invention, the imaging position Pb2 corresponds to the “fourth imaging position” of the invention, the intersection point Ia corresponds to the “first intersection point” of the invention, and the intersection point Ib corresponds to the “second intersection point” of the invention. The optical axis direction Doa corresponds to the “first direction” of the invention.

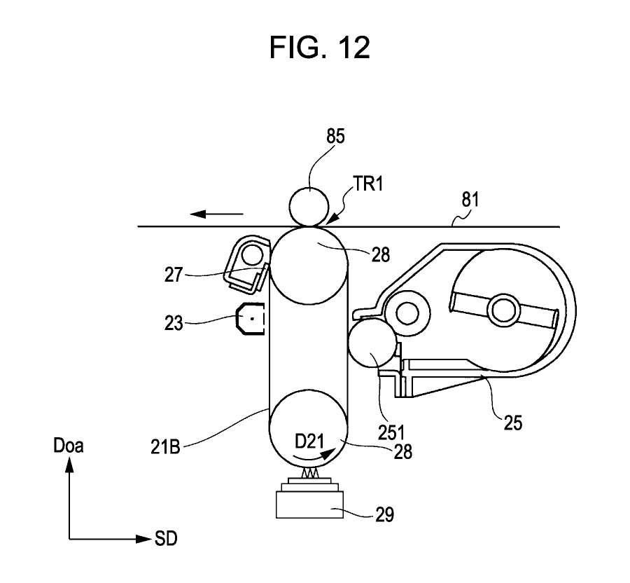

The invention is not limited to the embodiments described above, and the embodiments can be modified in various ways within the spirit and scope of the invention. FIG. 12 is a diagram illustrating a modification of an image forming apparatus according to the invention. This modification differs from the embodiments described above in the shape of a photosensitive body. That is, in this modification, a photosensitive belt 21B is used instead of the photosensitive drum 21. Because other members are the same as the embodiments described above, such members are denoted by the same or similar numerals and the description thereof is omitted.

In this modification, the photosensitive belt 21B is looped over two rollers 28 that extend in the main scanning direction MD. The photosensitive belt 21B is rotated in a predetermined rotation direction D21 by a drive motor (not shown). The charger 23, the line head 29, the developing section 25, and the photosensitive-body cleaner 27 are disposed around the photosensitive belt 21B in the rotation direction D21. These members perform charging, forming of a latent image, and developing of toner.

In this modification, the line head 29 is disposed so as to face a looped-over portion of the photosensitive belt 21B at which the photosensitive belt 21B is looped over one of the rollers 28. The rollers 28 are cylindrical. Therefore, the looped-over portion of the photosensitive belt 21B has a finite curvature. The line head 29 is disposed so as to face the looped-over portion for the following reason. That is, an extended portion of the photosensitive belt 21B flutters to a greater degree than the looped-over portion. By disposing the line head 29 so as to face the looped-over portion that flatters to a smaller degree than the extended portion, the distance between the line head 29 and the surface of the photosensitive belt 21B can be stabilized. However, even if the distance is stabilized, the position of the surface of the photosensitive belt 21B may flatter because the cross-sectional shape of the roller 28 is not a perfect circle or for other reasons. Therefore, it is preferable that the invention be applied to such a structure.

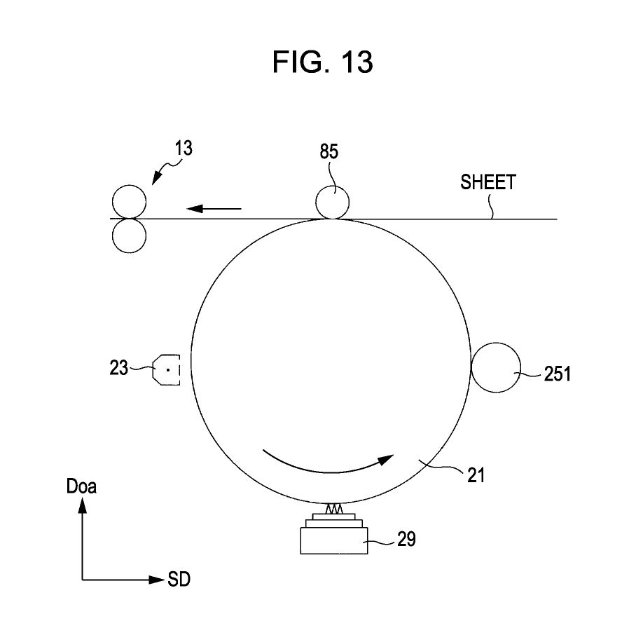

FIG. 13 is a diagram illustrating another modification of an image forming apparatus according to the invention. This modification differs from the first embodiment in that the transfer belt 81 is not used. That is, in this modification, a toner image formed on the photosensitive drum 21 is directly transferred from the transfer roller 85 onto a sheet, and then the toner image is fixed by the fixing unit 13. In this structure, the position of the surface of the photosensitive drum 21 may vary because the cross-sectional shape of the photosensitive drum 21 is not a perfect circle, and it is preferable that the invention be applied to this structure.

In the embodiments, the peak strengths of the light emitting element at the wavelengths λ1 and λ2 are not specified. However, the peak strengths at the wavelengths λ1 and λ2 may be greater than half the maximum value of the emission spectrum. In this case, the depth of focus can be more effectively increased.

In the embodiments, the optical system forms an inverted reduced image with a negative magnification having an absolute value smaller than one. However, the magnification of the optical system is not limited thereto. The magnification may be positive and may have an absolute value equal to or larger than one.

In the embodiments, the lenses are arranged in three lines in a staggered manner in the lens arrays LA1 and LA2. However, the arrangement of the lenses is not limited thereto, and other arrangements, such as in four lines in a staggered manner, can be adopted.

In the embodiments, the optical systems are arranged at a distance Lls in the sub-scanning direction SD. However, the optical systems may not be arranged at a regular distance.

In the embodiments, the lenses LS1 and LS2 are formed on the back surfaces of the lens arrays LA1 and LA2. However, the lenses LS1 and LS2 may be formed, for example, on the front surfaces of the lens arrays LA1 and LA2.

In the embodiments, the lens arrays LA1 and LA2 include the light transmissive substrates SB1 and SB2, which are made of glass, and the lenses LSa1, LSa2, and the like, which are made of resin. However, the lens arrays LA1 and LA2 may be integrally formed.

In the first embodiment, the plurality of light emitting element groups EG are arranged in three lines in a staggered manner. However, the arrangement of the plurality of light emitting element groups EG is not limited thereto.

In the embodiments, fifteen light emitting element E constitutes the light emitting element group EG. However, the number of the light emitting elements E that constitute the light emitting element group EG is not limited thereto.

In the embodiments, the plurality of light emitting elements E included the light emitting element group EG are arranged in two lines in a staggered manner. However, the arrangement of the plurality of light emitting elements E in the light emitting element group EG is not limited thereto.

In the embodiments, bottom emission organic EL devices are used as the light emitting elements E. However, top emission organic EL devices may be used as the light emitting elements E. Alternatively, light emitting diodes (LEDs) other than the organic EL devices may be used as the light emitting elements E.

In the embodiments, the light emitting element E has an emission spectrum with peaks at the wavelengths λ1 and λ2. However, it is not necessary that the light emitting element E have peaks at the wavelengths λ1 and X2. As long as the light emitting element E can emit light having the wavelength λ1 and light having the wavelength λ2, the depth of focus can be increased.

### EXAMPLE

An example of the invention will be described below. However, the invention is not limited to the example, and can be modified within the spirit an scope of the invention, and such modification are included in the technical scope of the invention.

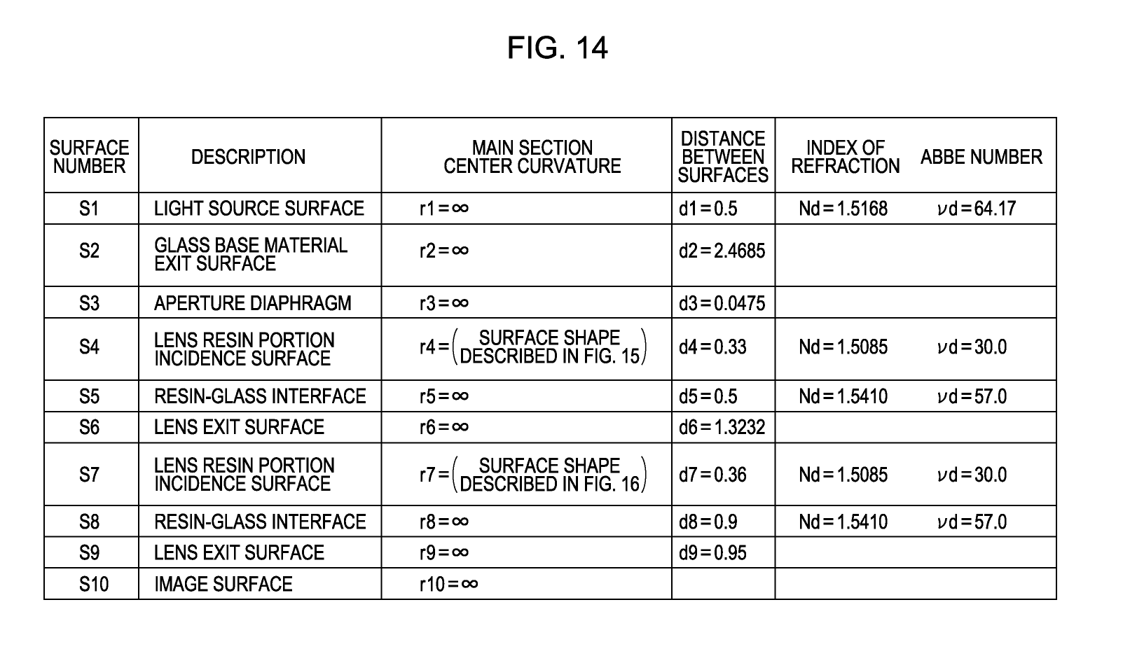

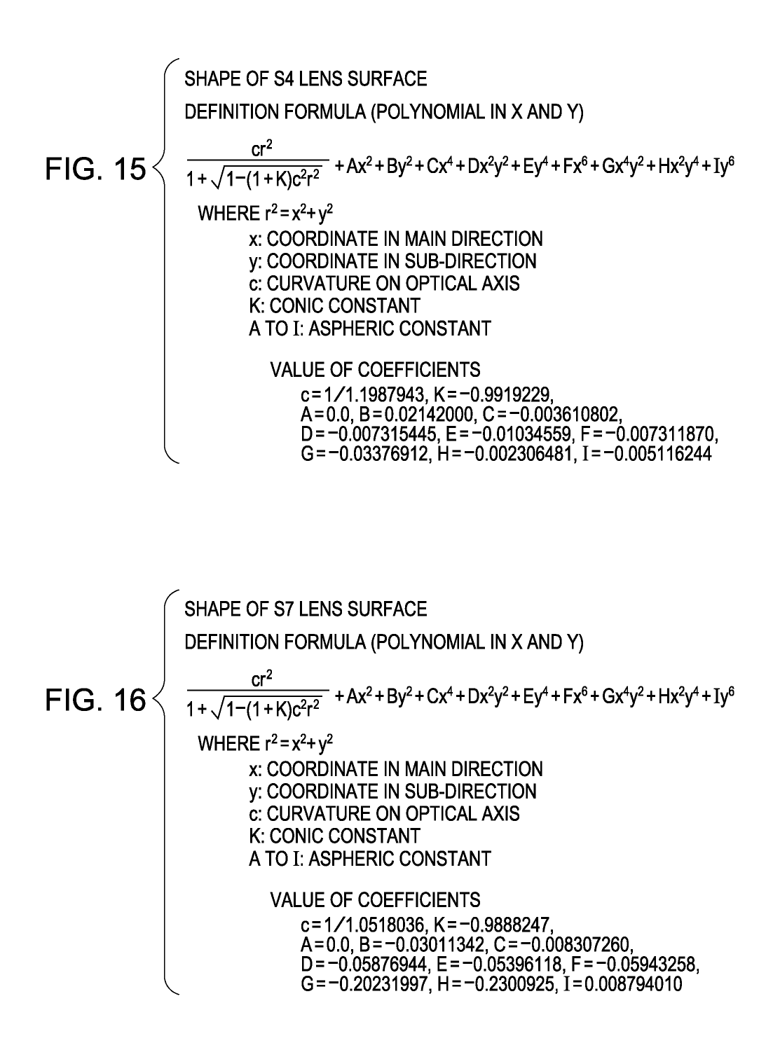

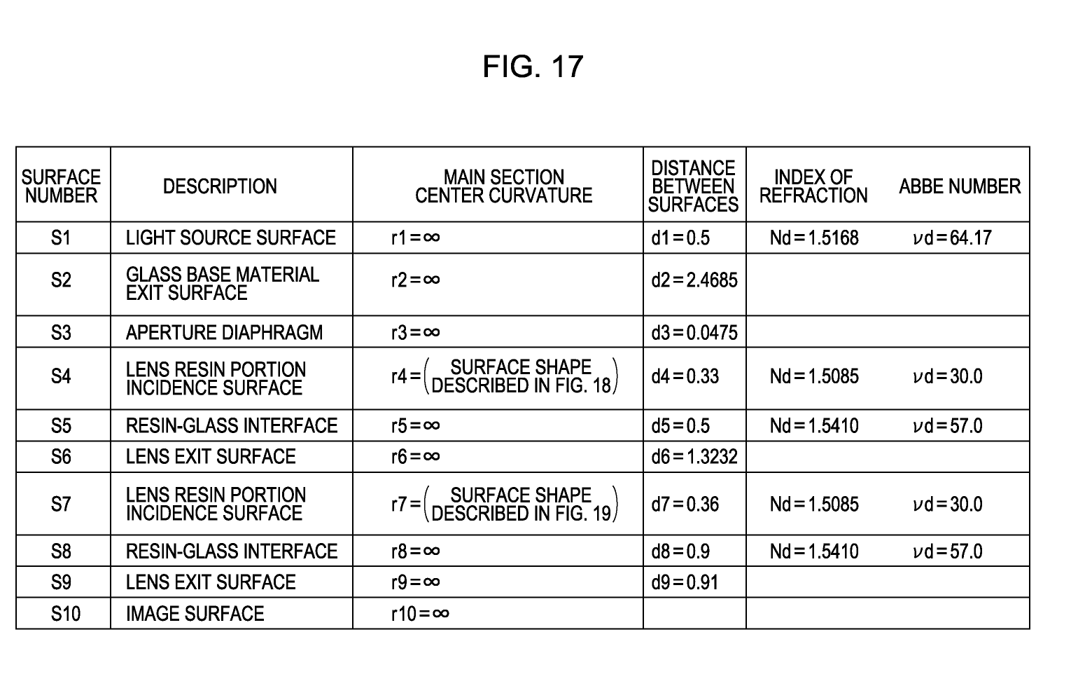

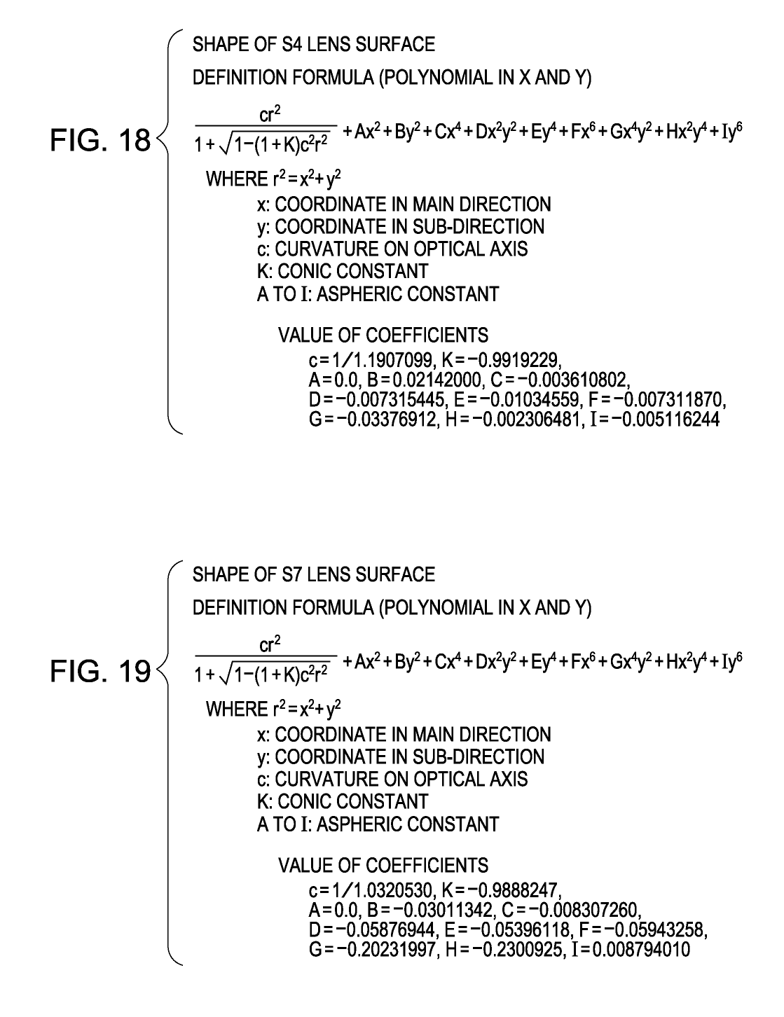

A specific example using a line head, which is described in the third embodiment using FIG. 10 and the like and includes three optical systems disposed at different positions with respect to the sub-scanning direction SD, will be described. FIG. 14 is a table of lens data of an upstream optical system and a downstream optical system in the example. FIG. 15 shows summary data about the shape of a S4 surface of the upstream optical system and the downstream optical system. FIG. 16 shows summary data about the shape of a S7 surface of the upstream optical system and the downstream optical system. FIG. 17 is a table of lens data of a middle optical system in the example. FIG. 18 shows summary data about the shape of a S4 surface of the middle optical system. FIG. 19 shows summary data about the shape of a S7 surface of the middle optical system.

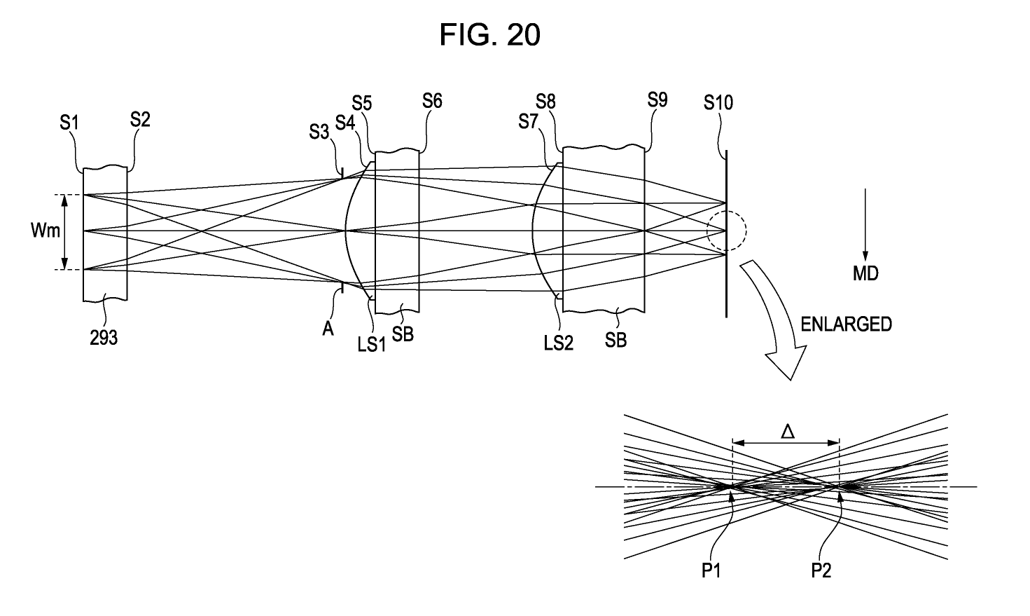

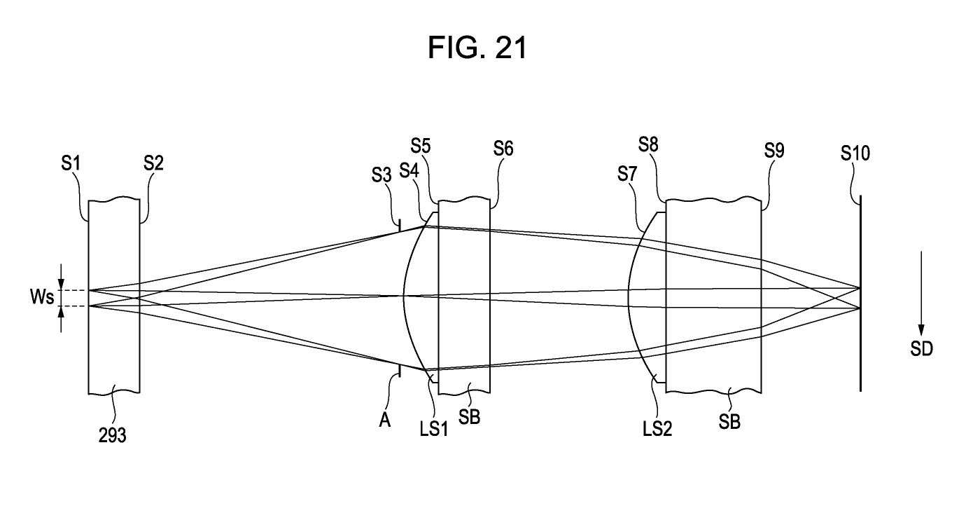

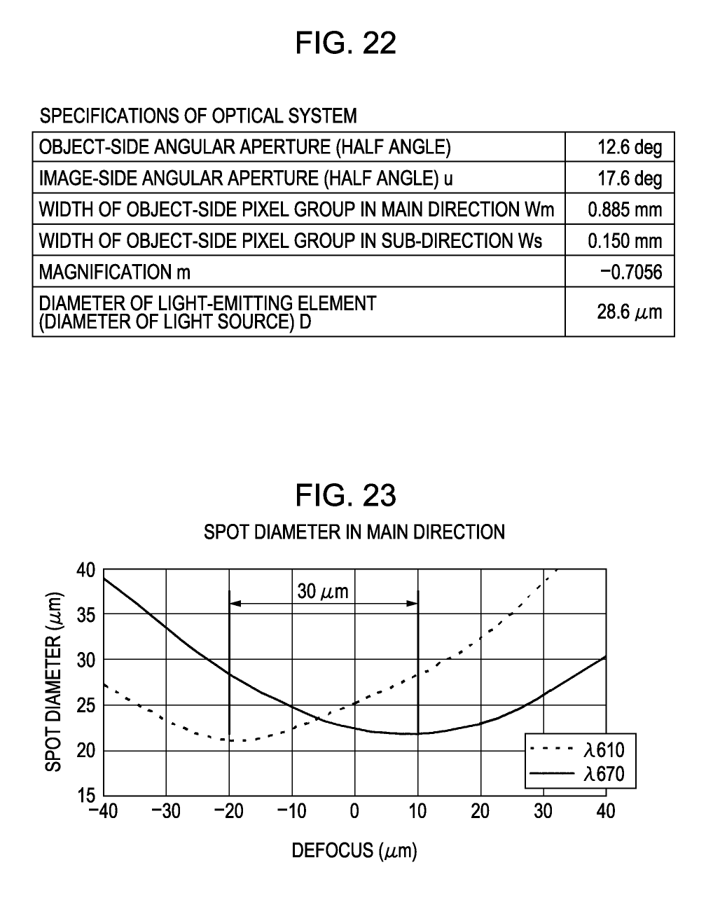

In the example, the optical axis OAb of the middle optical system constituted by LS2b and LS1b passes through the center of curvature CT21 of the photosensitive drum 21 (FIG. 10), the radius of curvature R of the photosensitive drum 21 is 39 mm (diameter of the photosensitive drum is φ78 mm), and the variation range of the position of the peripheral surface of the photosensitive drum 21 is about 25 μm (FIG. 8). The distance Lls between the optical systems is 1.77 mm (FIG. 10). The distance between the lens exit surface S9 and the image surface S10 is differentiated between the upstream and downstream optical systems and the middle optical system by 40 μm, so that the distance d≈, 40 μm. FIG. 20 is a ray diagram of the upstream and downstream optical systems in a section taken in the main scanning direction. FIG. 21 is a ray diagram of the upstream and downstream optical systems in a section taken in the sub-scanning direction. FIG. 22 is a table of specifications of an optical system used to obtain the ray diagrams of FIGS. 20 and 21. The ray diagrams of FIGS. 20 and 21 were obtained by using an optical system whose specifications, shown in FIG. 22, were as follows: the width of the object-side pixel group in the main direction (the width Wm in FIG. 21) was 0.885 mm, the width of the object-side pixel group in the sub-direction (Ws in FIG. 22) was 0.150 mm, the diameter D of the light emitting element was 28.6 μm, the object-side open angle (semi-angle) was 12.6°, the image-side angular aperture u (semi-angle) was 17.6°, and the magnification of the optical system was −0.7056.

As illustrated in lens data of FIGS. 14 to 16 and light ray diagrams of FIGS. 20 and 21, each of the upstream and downstream optical systems included two lenses. The two lenses were made of a lens material (resin) having a small Abbe number (νd=30).

As a result, each of the upstream and downstream optical systems had a comparatively high chromatic aberration. Light emitted from the light emitting element and having an emission spectrum with peaks at two wavelengths (λ1 and λ2) was focused with the optical system having a high chromatic aberration. As illustrated in the enlarged view of FIG. 20, the light having the wavelength λ1 and the light having the wavelength λ2 were respectively imaged at the imaging positions P1 and P2 that were separated from each other by a distance Δ in the optical axis direction. Therefore, the exposure surface RS is located between the first imaging position P1 and the second imaging position P2, so that, even if the position of the exposure surface ES deviated to some extent, the variation in the size of the spot (converged light) can be suppressed, whereby a good exposure can be realized.

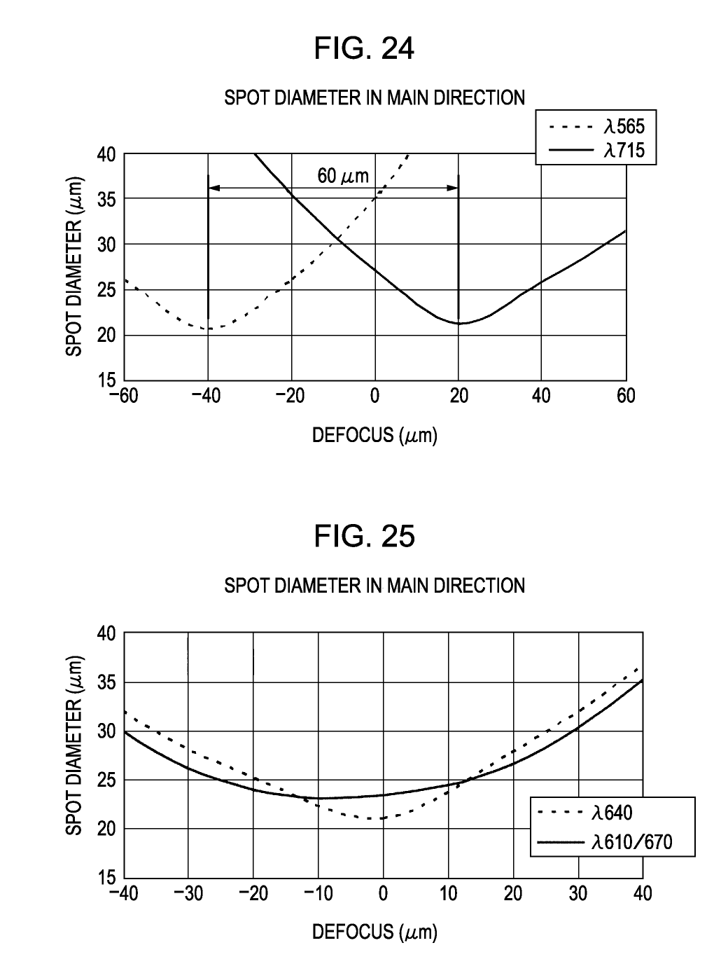

FIGS. 23 and 24 are graphs illustrating the imaging position of the light having the wavelength λ1 and the imaging position of the light having the wavelength λ2 obtained by performing a simulation. To be specific, FIG. 23 illustrates the diameter of a spot formed when the optical system of the example converged the light having a wavelength λ1=610 nm to the spot (broken-line curve) and the diameter of a spot formed when the optical system of the example converged the light having a wavelength λ=670 nm to the spot (solid-line curve). FIG. 24 illustrates the diameter of a spot formed when the optical system of the example converged the light having a wavelength λ1=565 nm to the spot (broken-line curve) and the diameter of a spot formed when the optical system of the example converged the light having a wavelength λ=715 nm to the spot (solid-line curve). In FIGS. 23 and 24, the horizontal axis represents the defocus (μm) and the vertical axis represents the spot diameter (μm). That is, these graphs illustrate variation of the diameter of the spot SP (the diameter in the main scanning direction) relative to the displacement (defocus) of the spot SP in the optical axis direction. The minimal point of the curve corresponds to the imaging position of a light having a wavelength corresponding to the curve.

As illustrated in FIG. 23, the imaging position of a light having the wavelength λ1 (=610 nm) and the imaging position of a light having the wavelength λ2 (=670 nm) were separated from each other by a distance of 30 μm in the optical axis direction Doa. That is, by using a light source that emitted a light having a wavelength of 610 nm and a light having a wavelength of 670 nm, the distance Δ between the imaging positions became 30 μm, whereby an effect was obtained in that the apparent depth of focus of the optical system was increased. As illustrated in FIG. 24, the imaging position of a light having the wavelength λ1 (=565 nm) and the imaging position of a light having the wavelength λ2 (=715 nm) were separated from each other by a distance 60 μm in the optical axis direction Doa. That is, by using a light source that emitted a light having a wavelength of 565 nm and a light having a wavelength of 715 nm, the distance Δ between the imaging positions became 60 μm, whereby an effect was obtained in that the apparent depth of focus of the optical system was increased.

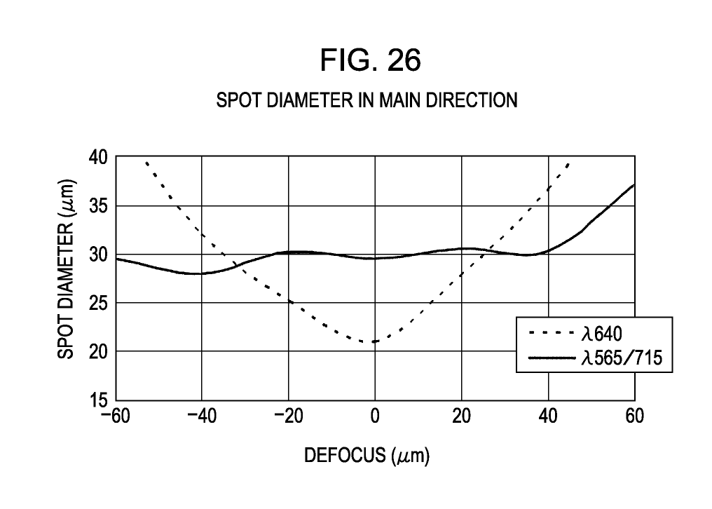

FIGS. 25 and 26 are graphs illustrating an increase in the depth of focus of the optical system, which were obtained by performing simulation. In FIGS. 25 and 26, the horizontal axis represents the defocus (μm), and the vertical axis represents the spot diameter (μm). That is, these graphs illustrate variation of the diameter of the spot SP (the diameter in the main scanning direction) relative to the displacement (defocus) of the spot SP in the optical axis direction. In FIG. 25, the spot formed by focusing a light having two wavelength components of 610 nm and 670 nm and the spot formed by focusing a light having a wavelength of 640 nm are compared with each other. In FIG. 26, the spot formed by focusing a light having two wavelength components of 565 nm and 715 nm and the spot formed by focusing a light having a wavelength of 640 nm are compared with each other.

The imaging position of the light having the wavelength of 610 nm and the imaging position of the light having the wavelength of 670 nm are separated from each other in the optical axis direction by 30 μm (=distance Δ). Therefore, as illustrated in FIG. 25, when the light having the two wavelength components were focused, variation in the spot SP is smaller and the increase in the apparent depth of focus was larger than the case when the light having the wavelength of 640 nm was focused.

Likewise, the imaging position of the light having the wavelength of 565 nm and the imaging position of the light having the wavelength of 715 nm were displaced from each other in the optical axis direction by 60 μm (=distance Δ). Therefore, as illustrated in FIG. 26, when the light having the two wavelength components was focused, variation in the spot SP was smaller and the increase in the apparent depth of focus was larger than the case when the light having the wavelength of 640 nm was focused.

Moreover, in any of FIGS. 25 and 26 (FIGS. 23 and 24), the distance Δ (=30 μm, 60 μm) between the imaging positions is equal to or larger than the variation range of the position of the peripheral surface of the photosensitive drum 21 (=25 μm) (FIG. 9). Therefore, irrespective of the positional variation of the peripheral surface of the photosensitive drum 21, variation of the size of the spot is suppressed, whereby a good exposure can be realized.

This distance Δ satisfied the expression 1, so that influence on the imaging performance such as aberration was suppressed, whereby a better exposure could be realized. That is, the right hand side of the expression 1 was

|−0.7056|×28.6 μm/tan(17.6°)=63.6 μm.

The distance Δ (=30 μm, 60 μm) between the imaging positions illustrated in FIGS. 25 and 26 (FIGS. 23 and 24) was shorter than 63.6 μm.

As with the upstream and downstream optical systems, the apparent depth of focus of the middle optical system was increased and the middle optical system was configured to satisfy the expression 1, so that an advantage the same as that of the upstream and downstream optical systems was obtained.

The entire disclosure of Japanese Patent Applications No. 2009-147864, filed on Jun. 22, 2009 is expressly incorporated by reference herein.

What is claimed is:

1. An image forming apparatus comprising:
an image carrier that carries an image; and
an exposure head including
a light emitting element that emits a light having a first wavelength and a light having a second wavelength, and
an optical system that focuses the light having the first wavelength at a first imaging position and focuses the light having the second wavelength at a second imaging position that is different from the first imaging position with respect to a first direction, the optical system having an optical axis extending in the first direction,
wherein a surface of the image carrier is located between the first imaging position and the second imaging position.

2. The image forming apparatus according to claim 1,
wherein the light emitting element has an emission spectrum having peaks at the first wavelength and the second wavelength.

3. The image forming apparatus according to claim 1,
wherein the image carrier is cylindrical,
wherein the exposure head exposes the surface of the image carrier that rotates, and
wherein a distance Δ between the first imaging position and the second imaging position with respect to an optical axis direction of the optical system is equal to or larger than a width by which the surface of the image carrier moves in the optical axis direction of the optical system while the image carrier rotates once.

4. The image forming apparatus according to claim 1, further comprising:
an aperture diaphragm for limiting an amount of light that enters the optical system,
wherein an expression
Δ≦|m|×D/tan(u)
is satisfied, where Δ is a distance between the first imaging position and the second imaging position with respect to an optical axis direction of the optical system, D is a diameter of the light emitting element, m is a magnification of the optical system, and u is an image-side angular aperture that is half an angle between two lines connecting an image point of the optical system and ends of a diameter of an entrance pupil.

5. The image forming apparatus according to claim 1,
wherein the exposure head further includes
a second light emitting element that emits a light having a third wavelength and a light having a fourth wavelength, and
a second optical system that focuses the light having the third wavelength at a third imaging position and focuses the light having the fourth wavelength at a fourth imaging position, and
wherein the surface of the image carrier is located between the third imaging position and the fourth imaging position.

6. The image forming apparatus according to claim 5,
wherein the optical axis of the optical system and an optical axis of the second optical system extend in the first direction, and
wherein the first imaging position and the third imaging position are separated from each other in the first direction by a distance d that is equal to a distance between a first intersection point and a second intersection point with respect to the first direction, the first intersection point being a point at which the optical axis of the optical system intersects the image carrier, the second intersection point being a point at which the optical axis of the second optical system intersects the image carrier.

7. An exposure head comprising:
a light emitting element that emits a light having a first wavelength and a light having a second wavelength; and
an optical system that focuses the light having the first wavelength at a first imaging position and focuses the light having the second wavelength at a second imaging position,
wherein the first imaging position is located on one side of an exposure surface and the second imaging position is located on the other side of the exposure surface.
